(19) United States
(12) Patent Application Publication
(10) Pub. No.: US 2026/0361563 A1
(43) Pub. Date: Nov. 12, 2026

(54) METHOD FOR IMPLEMENTING ONLINE MEETING IN A NON-REAL-TIME MANNER AND DEVICE FOR PERFORMING SAME

(71) Applicant: Jong Yoon CHUN, Yeoju-si (KR)

(72) Inventor: Jong Yoon CHUN, Yeoju-si (KR)

(21) Appl. No.: 19/721,845

(22) Filed: Jun. 26, 2026

Related U.S. Application Data
(63) Continuation of application No. PCT/KR2024/021180, filed on Dec. 26, 2024.

(30) Foreign Application Priority Data
Dec. 28, 2023 (KR) 10-2023-0194575

(51) Int. Cl. H04L 12/18

(52) U.S. Cl. CPC H04L 12/1831; H04L 12/1822

(57) ABSTRACT

A computer-implemented method for implementing an online meeting in a non-real-time manner includes receiving a request for the online meeting including meeting duration, meeting content, information about meeting participants, and meeting classification information from a host terminal, obtaining video data related to the meeting content, and generating an online meeting room including a content object containing the video data. The online meeting room further includes a conversation thread object based on text input from the meeting participants, and a meeting history object representing a historical relationship between the online meeting room and one or more other online meeting rooms. The method further includes controlling a progress of the online meeting by providing the online meeting room to each participant terminal during the meeting duration in response to a request from each participant terminal of the meeting participants, so that the online meeting proceeds with non-real-time participation by the meeting participants.

### CROSS REFERENCE TO RELATED APPLICATIONS

This is a continuation application of International Patent Application No. PCT/KR2024/021180 filed on Dec. 26, 2024, which claims priority to Korean patent application No. 10-2023-0194575 filed on Dec. 28, 2023, contents of each of which are incorporated herein by reference in their entireties.

### BACKGROUND

### Technical Field

The present disclosure relates to a method for implementing an online meeting in a non-real-time manner and a device for performing the same.

### Description of Related Technology

With the development of an internet environment, technologies for users to hold meetings through an electronic system have evolved in various ways. As a widely used meeting technology, there are well-known technologies that enable meetings between users based on messenger technology, which remotely connects users' communication environments and allows real-time information exchange.

### SUMMARY

One aspect is to provide a meeting service that enables users to communicate more smoothly without being restricted by time or location.

Another aspect is for enhancing the effectiveness of meetings by providing a meeting service that offers a more efficient meeting environment to achieve the goals of the meeting.

However, aspects are not limited to those described herein, and other unmentioned aspects would be apparent to one of ordinary skill in the art from the following description.

Another aspect is a computer-implemented method for implementing an online meeting in a non-real-time manner by a plurality of users using a meeting service device, wherein the meeting service device includes a memory, a processor, and one or more programs stored in the memory and configured to be executed by the processor, the method including: receiving a request for the online meeting including meeting duration, meeting content, information about meeting participants, and meeting classification information from a host terminal; obtaining video data related to the meeting content; generating an online meeting room that includes a content object containing the video data, wherein the online meeting room further includes (i) a conversation thread object based on text input from the meeting participants, and (ii) a meeting history object representing a historical relationship between the online meeting room and one or more other online meeting rooms associated with the online meeting room; and controlling a progress of the online meeting by providing the online meeting room to each participant terminal through a network during the meeting duration in response to a request from each participant terminal of the meeting participants, so that the online meeting proceeds with non-real-time participation by the meeting participants.

In one embodiment, the meeting classification information may include at least one classification information selected from the group consisting of a meeting host, a meeting participant, a department name, a project name, a specific work or task in a workflow, a technical field, and a past meeting held prior to a current meeting.

In one embodiment, the online meeting room may further include: a base information object containing the received request for the online meeting, and the controlling the progress of the online meeting with the non-real-time participation may further include: receiving user input regarding the meeting classification information from a participant terminal; and updating the base information object and/or the meeting history object based on the received user input.

In one embodiment, the meeting history object may visualize to provide the historical relationship between the online meeting in the online meeting room and meetings prior to the generation of the online meeting room, in a sequential and/or hierarchical manner, based on the meeting classification information.

In one embodiment, the meeting service device, upon receiving the user input from the participant terminal regarding a classification range and/or a classification period for the historical relationship, may apply the received classification range and/or the classification period to the meeting history object to provide the historical relationship.

In one embodiment, when at least one of the nodes among a plurality of nodes visualizing the historical relationship is selected by the participant terminal, the meeting history object may further visualize to provide an additional historical relationship, different from the historical relationship of the online meetings, based on the classification information corresponding to the selected node.

In one embodiment, the meeting history object may include at least one selected from the group consisting of a history chart visualizing the historical relationship, a meeting summary for each of the one or more other online meeting rooms, and at least one access link to each of the one or more other online meeting rooms.

In one embodiment, the method may further include: receiving user input for searching a meeting room; and providing search results including one or more online meeting rooms among a plurality of online meeting rooms stored in a database of the meeting service device; wherein the one or more online meeting rooms have (i) a similarity between information in each request for an online meeting and a text in the user input and/or (ii) a frequency of occurrence of the text in each conversation thread object being equal to or greater than a predetermined level.

In one embodiment, the method may further include: receiving user input for searching a question; and providing search results including one or more online meeting rooms, among a plurality of online meeting rooms stored in a database of the meeting service device; each of the one or more online meeting rooms includes the conversation thread object that has (i) a first text with a semantic similarity to the question in the user input that is equal to or greater than a predetermined level, and/or (ii) a second text identified as an answer to the question.

In one embodiment, the controlling the progress of the online meeting with the non-real-time participation may include: providing the online meeting room to each participant terminal whose participation response to the request for the online meeting has been confirmed.

In one embodiment, the method may further include: sending an invitation message including the meeting duration and the meeting content to each of the participant terminals of the meeting participants; a count of the meeting participants is not less than 3; and approving the request for the online meeting when the participation response for the invitation message are received from at least two meeting participants' terminals within a predetermined period.

In one embodiment, the method may further include: after the approving the request for the online meeting, sending an approval message for the approval of the request for the online meeting to the host terminal.

In one embodiment, the obtaining the video data may be performed in response to the approval of the request for the online meeting.

In one embodiment, the obtaining the video data may be performed receiving the request for the online meeting in response to a request from the host terminal.

In one embodiment, the method may further include: after the receiving the request for the online meeting, obtaining an additional video data from the host terminal, the participant terminal, or a terminal of another user designated by the host terminal, and the content object may further include the additional video data.

In one embodiment, the obtaining the video data may include obtaining the video data from the meeting content when the meeting content includes the video data.

In one embodiment, the controlling the progress of the online meeting with the non-real-time participation may further include: updating the conversation thread object based on a question message received from a first participant terminal of a questioner among the meeting participants; providing a question notification message regarding an addition of the question message to the host terminal and/or the participant terminal; and updating the conversation thread object based on an answer message received in response to the question message from the host terminal or the participant terminal.

In one embodiment, the providing the question notification message may include: when a responder is designated by the questioner for the question message, providing the question notification message regarding the addition of the question message and the designation of the responder only to a second participant terminal of the designated responder.

In one embodiment, the updating the conversation thread object based on the question message may include: granting access to the question message only to the designated responder when a responder is designated by the questioner.

In one embodiment, the question message may be updated in response to a modification request from the first participant terminal, and the answer message may be updated in response to a modification request from the second participant terminal that provided the answer message.

In one embodiment, the method may further include: providing a result of sorting messages according to a message type of messages included in the conversation thread object, and the message type may include at least one selected from the group consisting of a question-based type, an answer-based type, an opinion-based type, a department-based type, a participant-based type, and a keyword-based type.

In one embodiment, the conversation thread object may include a thread of conversation units based on at least one input selected from the group consisting of a text, an image, a video, and an audio of the meeting participants.

In one embodiment, the receiving the request for the online meeting may further include: recommending candidate meeting participants to the host terminal based on the meeting content and/or the meeting classification information; receiving, from the host terminal, user input for a plurality of meeting participants including the recommended candidate meeting participants; and determining the meeting participants of the online meeting based on the user input.

In one embodiment, the providing the online meeting room may further include: providing a participant list including a result of sorting user information of the meeting participants based on non-real-time participation information of each of the meeting participants for the online meeting rooms.

In one embodiment, the non-real-time participation information may include at least one selected from the group consisting of initial access time, most recent access time, confirmation time of participation response, access frequency, current access status for the online meeting room, and conversation participation rate for the conversation thread object.

In one embodiment, the method may further include: obtaining viewing information of the video data for each of the meeting participants based on access information to the content object of the participant terminal of each meeting participant; and providing the viewing information of each meeting participant to the host terminal.

In one embodiment, the controlling the progress of the online meeting with the non-real-time participation may further include: granting write permission to the conversation thread object based on the viewing information to the participant terminal where whose viewing of the video data is confirmed.

Another aspect is a computer program stored in a non-transitory computer-readable recording medium, programmed to perform each step included in a method for implementing an online meeting in a non-real-time manner by a plurality of users using a meeting service device. The method may include: receiving a request for the online meeting including meeting duration, meeting content, information about meeting participants, and meeting classification information from a host terminal; obtaining video data related to the meeting content; generating an online meeting room that includes a content object containing the video data, wherein the online meeting room further includes (i) a conversation thread object based on text input from the meeting participants, and (ii) a meeting history object representing a historical relationship between the online meeting room and one or more other online meeting rooms associated with the online meeting room; and controlling a progress of the online meeting by providing the online meeting room to each participant terminal through a network during the meeting duration in response to a request from each participant terminal of the meeting participants, so that the online meeting proceeds with non-real-time participation by the meeting participants.

Another aspect is a non-transitory computer-readable non-transitory recording medium storing a computer program programmed to perform each step included in a method for implementing an online meeting in a non-real-time manner by a plurality of users using a meeting service device. The method may include: receiving a request for the online meeting including meeting duration, meeting content, information about meeting participants, and meeting classification information from a host terminal; obtaining video data related to the meeting content; generating an online meeting room that includes a content object containing the video data, wherein the online meeting room further includes (i) a conversation thread object based on text input from the meeting participants, and (ii) a meeting history object representing a historical relationship between the online meeting room and one or more other online meeting rooms associated with the online meeting room; and controlling a progress of the online meeting by providing the online meeting room to each participant terminal through a network during the meeting duration in response to a request from each participant terminal of the meeting participants, so that the online meeting proceeds with non-real-time participation by the meeting participants.

Another aspect is a meeting service device for implementing an online meeting in a non-real-time manner by a plurality of users, including: a memory configured to store at least one instruction; and a processor configured to execute the one or more instructions stored in the memory, wherein the instructions, when executed by the processor, cause the processor to: receiving a request for the online meeting including meeting duration, meeting content, information on meeting participants, and meeting classification information from a host terminal; obtaining video data related to the meeting content; generating an online meeting room that includes a content object containing the video data, wherein the online meeting room further includes (i) a conversation thread object based on text input from the meeting participants, and (ii) a meeting history object representing a historical relationship between the online meeting room and one or more other online meeting rooms associated with the online meeting room; and controlling a progress of the online meeting by providing the online meeting room to each participant terminal through a network during the meeting duration in response to a request from each participant terminal of the meeting participants, so that the online meeting proceeds with non-real-time participation by the meeting participants.

According to one embodiment of the present disclosure, users can participate in a meeting non-real-time without being restricted by time or location. Since simultaneous participation of several users is not required, all participants involved in the meeting can flexibly join at their preferred times and locations during the meeting period without any limitations on the number of participations, thereby enabling the meeting to proceed more effectively.

Furthermore, users are able to deliberate thoroughly during the meeting period before presenting their opinions, allowing for more in-depth discussions. This contributes to a more effective progression of the meeting. Additionally, as users are given enough time to prepare all necessary materials for the meeting, sufficient resources and background data can be prepared both qualitatively and quantitatively for various topics requiring discussion. Consequently, better discussions can take place among participants, making it easier to achieve the intended objectives of the meeting.

According to another embodiment of the present disclosure, the efficiency of meetings can be improved by providing the history of past meetings related to the current meeting. For instance, if at least some participants are unaware of the history of previous meetings conducted to achieve the current meeting's objectives, or if other meetings directly or indirectly related to the current topic were held in the past but current participants are unaware of them, redundant discussions about topics previously addressed may occur during the meeting. However, when meeting histories are provided, participants can review the histories of related past meetings beforehand, equipping themselves with a better understanding of the meeting flow and background knowledge. This preparation reduces unnecessary disputes and, as a result, enhances the overall efficiency of the meeting.

According to still another embodiment of the present disclosure, the efficiency of meetings can be enhanced by providing information on past similar questions and/or relevant answers related to user input. For example, search results regarding similar question-and-answer exchanges from previous meetings can be provided. This allows participants to review similar past interactions before posing questions, equipping them with greater knowledge as they join the meeting. As a result, unnecessary questions are reduced, ultimately improving the overall efficiency of the meeting.

The effects of the present disclosure are not limited to those mentioned above and should be understood to include all effects that can be inferred from the detailed description of the disclosure or the configuration of the invention described in the claims

### BRIEF DESCRIPTION OF THE DRAWINGS

FIG. 1 illustrates a block diagram of a meeting service system according to one embodiment.

FIG. 2 schematically shows a block diagram of the configuration of a meeting service device according to one embodiment.

FIG. 3 represents the modularization of software implemented by the meeting service device shown in FIG. 2.

FIG. 4 schematically illustrates the block configuration of meeting information according to one embodiment.

FIG. 5 exemplifies a flowchart showing the process of obtaining video data according to a first embodiment.

FIG. 6 exemplifies a flowchart showing the process of obtaining video data according to a second embodiment.

FIG. 7 exemplifies a flowchart showing the process of obtaining video data according to a third embodiment.

FIG. 8 schematically illustrates a block diagram of an online meeting room according to one embodiment.

FIG. 9 illustrates a conceptual diagram of a meeting history object according to one embodiment.

FIG. 10 illustrates a meeting history object associated with a project according to one embodiment.

FIG. 11 illustrates a meeting history object associated with a project according to another embodiment.

FIG. 12 illustrates a meeting history object related to past meetings conducted before the current meeting according to one embodiment.

FIG. 13 illustrates a meeting history object associated with meeting participants according to one embodiment.

FIG. 14 illustrates an exemplary diagram showing the display of online meeting room information on the screens of a host terminal and/or participant terminal according to one embodiment.

FIGS. 15A and 15B illustrate exemplary diagrams showing the process of displaying meeting search results on the screens of a host terminal and/or participant terminal according to one embodiment.

FIGS. 16A and 16B illustrate exemplary diagrams showing the process of displaying question-and-answer search results on the screens of a host terminal and/or participant terminal according to one embodiment.

FIGS. 17A and 17B illustrate exemplary diagrams showing the process of displaying summarized results on the screens of a host terminal and/or participant terminal according to one embodiment.

FIG. 18 illustrates an exemplary diagram showing the process of displaying non-real-time participation information on the screens of a host terminal and/or participant terminal according to one embodiment.

FIG. 19 illustrates an exemplary flowchart of a computer-implemented method for implementing an online meeting in a non-real-time manner by a meeting service device according to one embodiment.

FIG. 20 illustrates an exemplary flowchart of a computer-implemented method for implementing an online meeting in a non-real-time manner by a meeting service device according to another embodiment.

### DETAILED DESCRIPTION

Recently, video conferencing technologies based on video messenger systems, which combine messenger technology with vision technology, have been developed. Through these technologies, video conferences are held in which chat, voice, and video from users in remote locations are shared in real-time.

This video conferencing technology allows an organizer to schedule a meeting, notify participants of an agenda and a schedule, and ensure that the devices of both the organizer and participants are connected via a video messenger at a scheduled time. As a result, a video conference can take place, enabling the organizer and the participants to join in real time via chat, voice, or video to exchange opinions on the agenda. In this regard, Korean Patent Publication No. 10-2007-0056747 (published on Jun. 4, 2007) discloses a method and a control device for opening a video conference by using the web and a recording medium including a program for implementing the same.

However, conventional meeting technologies have the following flaws:

First, conventional meeting technologies commonly require the simultaneous participation of multiple users at a designated time. The organizer must individually contact participants to coordinate schedules, going through a tedious process to find a mutually convenient time. This can result in delays in arranging the meeting schedule. Additionally, in some cases, a few participants may fail to join the meeting due to unsuccessful schedule coordination.

Second, the real-time nature of participation requires the quick presentation of opinions within a short timeframe, making it difficult to engage in in-depth discussions. During the meeting, unexpected questions or issues may arise, and the need for prompt responses often leaves little room for careful deliberation. As a result, participants frequently struggle to provide appropriate answers or opinions during the meeting, hindering meaningful discussions. This lack of depth in discussions can ultimately reduce the overall effectiveness of the meeting.

Third, it is challenging to prepare all the necessary resources for a meeting in real time. Even when the meeting agenda is predetermined, participants often lack sufficient materials or background data when joining the meeting. If unexpected questions or issues arise during the meeting that require additional resources, preparing those resources can take time, making it difficult to provide them promptly. Moreover, when the primary materials used in the meeting are only shared during the session, participants may struggle to thoroughly review or prepare in advance for many critical discussion points. This lack of preparation and pre-discussion review can reduce the effectiveness of the meeting.

As a result, there is a growing need to develop meeting technologies that enable users to participate more efficiently and provide a meeting environment that facilitates more effective communication.

Advantages and features of the disclosure, and methods for achieving same may be apparent from the embodiments described below with reference to the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims.

When determined to make the subject matter of the disclosure unclear, the detailed description of known functions or configurations may be skipped. The terms described below are defined considering the functions in embodiments of the disclosure and may be replaced with other terms according to the intention or practice of the user or operator. Therefore, the terms should be defined based on the overall disclosure.

When it is described that a part in the overall specification “includes” a certain component, this means that other components may be further included instead of excluding other components unless specifically stated to the contrary. Furthermore, terms such as “a unit,” and “a module” described in the specification refer to a unit that processes at least one function or operation, which can be implemented either in hardware or software, or as a combination of both hardware and software.

In the entire specification, the term “provide” can be interpreted as encompassing the process through which a target acquires specific information or transmits/receives information to/from a specific target, including the performance of related actions required during such processes.

Hereinafter, the embodiment of the present disclosure will be described in detail with reference to the accompanying drawings so that those of ordinary skill in the art may easily implement the present disclosure. However, the present disclosure can be implemented in various forms and is not limited to the embodiments described herein.

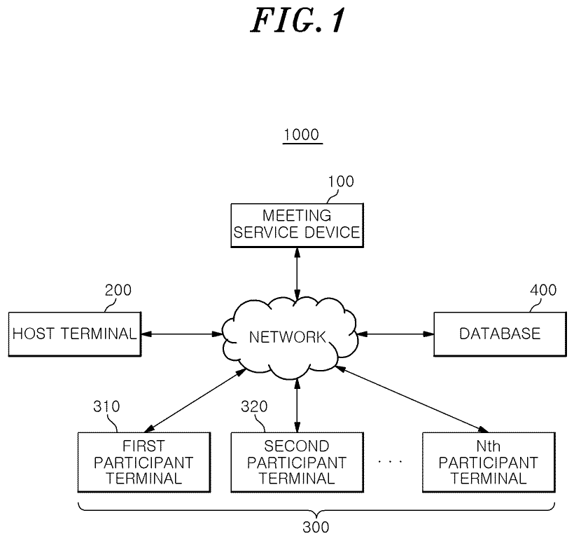

FIG. 1 is a block diagram illustrating a meeting service system 1000 according to one embodiment.

Referring to FIG. 1, the meeting service system 1000 may include a meeting service device 100, a host terminal 200, one or more participant terminals 300, and a database 400.

The meeting service device 100 provides a meeting environment for users to conduct meetings online in a non-real-time manner and enables the progression of meetings through non-real-time participation by meeting participants.

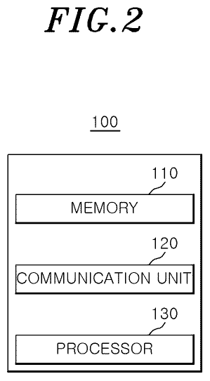

The meeting service device 100 can be implemented to perform the technical features according to the embodiments of the present disclosure. For example, the meeting service device 100 may generate an online meeting room based on a request for the online meeting received from the host terminal 200 and provide the online meeting room to each participant terminal 300 of the meeting participants. This allows the meeting service device 100 to control the progression of the online meeting through non-real-time participation by the meeting participants. Details regarding this will be described in detail below with reference to FIG. 2.

In one embodiment, the meeting service device 100 may be implemented as a computer operating through a computer program designed to realize the functions described in the present specification. For example, the meeting service device 100 may include a server. The server may include any type of computing system or computing device, such as a microprocessor, a mainframe computer, a digital processor, a portable device, or a device controller.

In another embodiment, the meeting service device 100 may refer to one or more nodes constituting the meeting service system 1000. For example, the meeting service device 100 may include any type of user terminal and/or server. Here, the user terminal may include any type of terminal capable of interacting with a server or other computing devices. The user terminal may include, for example, a mobile phone, a smartphone, a desktop computer, a laptop computer, a PDA (personal digital assistant), a slate PC, a tablet PC, and an ultrabook.

The host terminal 200 refers to a user terminal associated with the meeting host. For example, the host terminal 200 may correspond to the terminal linked to the user account of the meeting host among the users utilizing the meeting service provided by the meeting service device 100. Here, the meeting host refers to the user account that requests an online meeting. For instance, it may correspond to the user account of the user terminal that sends a request for online meeting to the meeting service device 100. However, it is not limited thereto. In one embodiment, there may be more than one meeting host. For example, the meeting host may include both the user account requesting the meeting creation and additional user accounts designated as meeting hosts by the requesting user account.

The participant terminal 300 refers to a user terminal associated with a meeting participant. For example, the participant terminal 300 may correspond to the terminal linked to the user account of a meeting participant among the users utilizing the meeting service provided by the meeting service device 100. Here, a meeting participant refers to a user account invited to participate in the meeting by the meeting host. For instance, it may correspond to any one of the user accounts included as meeting participants in the meeting request from the host terminal 200.

Hereinafter, for convenience of explanation, the host terminal 200 and the participant terminal 300 are described separately, but it is not limited thereto. The host terminal 200 and the participant terminal 300 can be understood as concepts distinguished based on whether the user is the meeting host or a meeting participant. They may be collectively understood as user terminals corresponding to the user accounts of a meeting host or participant. For example, in the case of multiple meetings, the meeting host and participants may differ at least partially for each meeting. As such, the host terminal 200 in one meeting may serve as the participant terminal 300 in another meeting or may be a user terminal unrelated to yet another meeting.

Each of the host terminal 200 and one or more participant terminals 300 according to one embodiment may install and store a meeting service application in their memory. For example, a meeting service application containing a computer program designed to implement the functions described in the present specification may be registered in an app store server (not shown) where various applications are uploaded. Further, the host terminal 200 and one or more participant terminals 300 may download and install the meeting service application from the application store server, and may communicate with the meeting service device 100 through the installed meeting service application to receive services such as the online meeting room, meeting history, and search results, which will be described later, from the meeting service device 100.

The meeting service application according to one embodiment may be a program module capable of communicating with external devices. Such program modules may be included in a terminal or other devices capable of communication therewith in the form of operating systems, application modules, and other program modules, and may be physically stored in various known storage devices. For example, the meeting service application may be a web-based application module operating on a computer's operating system, such as a PC, or a mobile application module operating on the operating system of a smartphone or tablet PC.

In another embodiment, each of the host terminal 200 and one or more participant terminals 300 may be provided with the following information while communicating with the meeting service device 100 on its own without a meeting service application, or may be provided with the following information through a web-based meeting service provided by the meeting service device 100.

Meanwhile, such program modules encompass routines, subroutines, programs, objects, components, data structures, and the like that implement the technical features according to the embodiments of the present disclosure or execute specific data types, but are not limited thereto.

The database 400 may store information about meetings, such as information about online meeting rooms to be described later. In one embodiment, the database 400 may store and manage a dataset of information about online meeting rooms, including the meeting host's information, information about the meeting participants 13, and other information to be described later. Further, at least some of the information, such as the meeting identifier, user identifier, and information about the components included in the online meeting room, may be used as metadata of the online meeting room's information to facilitate the retrieval of the online meeting room's information from the database 100.

In one embodiment, the database 400 may be one of the components of the meeting service system 1000. For example, the database 400 may exist outside the meeting service device 100 and be implemented in a manner that is communicable with the meeting service device 100. In this case, the database 400 may be managed and controlled by a different external server, which is distinct from the meeting service device 100.

In another embodiment, the database 400 may be one of the components of the meeting service device 100. For example, the meeting service device 100 may include a database 400, which is an entity responsible for storing and managing information about the meeting. The database 400 may be included within the meeting service device 100 or exist under the management of the meeting service device 100.

The database 400 according to one embodiment may be at least partially implemented in the cloud or include a separate storage server to provide storage space for the meeting service device 100.

At least some of the components included in the meeting service system 1000 may be interconnected. For example, the meeting service device 100 may be connected to the host terminal 200 and one or more participant terminals 300 through a network. Here, the network may be formed through various communication networks, such as wired and wireless networks, and may include various types of networks, such as a Local Area Network (LAN), a Metropolitan Area Network (MAN), or a Wide Area Network (WAN). In another example, the meeting service device 100 may be connected to the database 400 through a network or electrically.

Meanwhile, it will be understood by those skilled in the art that other general-purpose components may be further included in the meeting service system 1000, in addition to the components shown in FIG. 1. For example, the meeting service system 1000 may further include a mobile carrier server (not shown) to provide text messages related to the meeting to the meeting host or participants' user terminals, or a payment server (not shown) for billing purposes. Alternatively, in other embodiments, some of the components shown in FIG. 1 may be omitted.

FIG. 2 schematically shows a block diagram of the meeting service device 100 according to one embodiment.

Referring to FIG. 2, the meeting service device 100 may include a memory 110, a communication unit 120, and a processor 130. The configuration of the meeting service device 100 shown in FIG. 2 is just an example presented in a simplified form. In one embodiment, the meeting service device 100 may include other components to perform the computing environment of the meeting service device 100, and only some of the disclosed components may constitute the meeting service device 100.

The memory 110 can store at least one instruction that can be executed by the processor 130. In one embodiment, the memory 110 may store any form of information generated or determined by the processor 130, as well as any form of information received by the meeting service device 100. In one embodiment, the memory 110 may be a storage medium that stores a computer program to enable the processor 130 to perform the operations according to the embodiments of the present disclosure. Therefore, the memory 110 may refer to computer-readable media for storing the software code necessary to perform the embodiments of the present disclosure, the data to be executed by the code, and the results of the code's execution.

In one embodiment, the memory 110 may refer to any type of storage medium. For example, the memory 110 may include at least one type of storage medium, such as flash memory, hard disk, multimedia card micro type, card-type memory (e.g., SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), magnetic memory, magnetic disk, or optical disk. The meeting service device 100 may operate in association with web storage that performs the storage function of the memory 110 on the internet. The description of the aforementioned memory is merely an example, and the memory 110 in this disclosure is not limited to these types.

The communication unit 120 may be configured regardless of its communication type, such as wired or wireless, and may be implemented with various communication networks, such as a Personal Area Network (PAN) or a Wide Area Network (WAN). Further, the communication unit 120 can operate based on the well-known World Wide Web (WWW) and may use wireless transmission technologies for short-range communication, such as Infrared Data Association (IrDA) or Bluetooth. For example, the communication unit 120 may be responsible for transmitting and receiving data required to perform the techniques according to one embodiment of the present disclosure.

The processor 130 may overall control the operation of the meeting service device 100 and perform a series of actions to enable users to conduct non-real-time meetings online. In one embodiment, the processor 130 may be composed of at least one core and include a processor for data analysis and/or processing, such as the CPU (central processing unit), GPU (graphics processing unit), MCU (microcontroller unit), GPGPU (general-purpose graphics processing unit), or TPU (tensor processing unit) of the meeting service device 100.

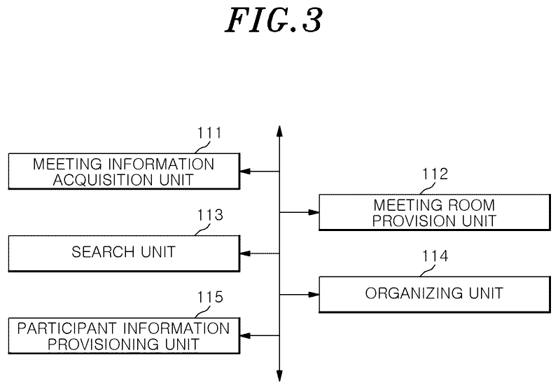

The processor 130 may perform the technical features of the embodiments of the present disclosure by executing at least one instruction stored in the memory 110. The various technical features performed by the processor 130 will be described with reference to FIG. 3.

FIG. 3 is a diagram illustrating the software implemented by the meeting service device 100 shown in FIG. 2, modularized. Referring to FIG. 3, the software implemented by the hardware processor 130, which executes at least one instruction stored in the memory 110, may be modularized into at least one of a meeting information acquisition unit 111, a meeting room provision unit 112, a search unit 113, an organizing unit 114, and a participant information provision unit 115. For example, the meeting information acquisition unit 111, the meeting room provision unit 112, the search unit 113, the organizing unit 114, and the participant information provision unit 115 may each be implemented as a computer program, and the instructions and data required for their execution may be stored in the memory 110 and executed by the processor 130, however, it is not limited thereto.

According to one embodiment of the present disclosure, the meeting information acquisition unit 111 can be implemented to acquire meeting information for opening an online meeting.

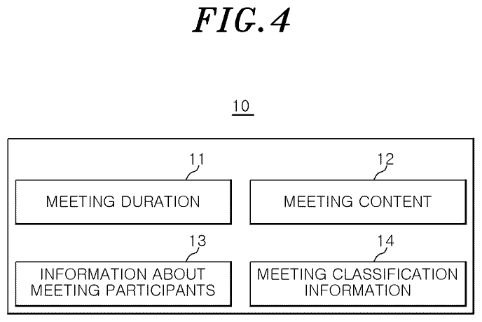

Specifically, the meeting information acquisition unit 111 can receive a meeting request that includes meeting information 10 from the host terminal 200. For example, an input menu for entering information to generate a meeting may be displayed through a meeting service application installed on the host terminal 200, and the meeting information acquisition unit 111 can receive the meeting request containing the meeting information 10 input by the host terminal 200 through the input menu. Throughout the specification, the meeting request may be used interchangeably with the request for online meeting. The details thereof will be explained with reference to FIG. 4.

FIG. 4 schematically shows a block diagram of meeting information 10 according to one embodiment.

Referring to FIG. 4, the meeting information 10 included in the meeting request may include at least one of meeting duration 11, meeting content 12, information about the meeting participants 13, and meeting classification information 14.

The meeting duration 11 includes information about the period during which the meeting will be conducted in a non-real-time manner. For example, the meeting duration 11 may include information about start and end times, or may include information about the start time and a time period (e.g., 3 days, 7 days, or one month). In one embodiment, the meeting duration 11 is obtained during the process of receiving the meeting request, and may be updated in subsequent process in response to requests from the host terminal 200 or participant terminal 300. In another embodiment, the meeting duration 11 may be obtained in the process subsequent to the receipt of the meeting request, in response to a request from the host terminal 200.

The meeting content 12 includes information about the topics to be covered in the meeting. For example, the meeting content 12 may include at least one of text data, image data, video data, or audio data for explaining the meeting agenda, or may include an electronic document including at least one of these types of data.

The information about the meeting participants 13 includes information about users who are eligible to participate in the meeting. For example, it may include user information (e.g., ID, name, company name, department name) of the user accounts invited to the meeting. In one embodiment, the number of users corresponding to the information about the meeting participants 13 may be set to N or more (where N is a natural number). For example, N may be 3 or more. In another example, N may be 4 or more, or 2 or more.

The meeting classification information 14 includes one or more classification details related to the meeting. For example, the meeting classification information 14 may include classification details indicating which technical field the meeting belongs to, or which task within a project the meeting is related to.

In one embodiment, the meeting classification information 14 may include at least one classification information from a meeting host, meeting participants, a department name, a project name, a specific work or task from the workflow, a technical field, and past meetings held prior to the meeting in question.

As a specific example, the classification information for the meeting host, the meeting participants, the department name, the project name, the specific work or task from the workflow, the technical field, and the past meetings held prior to the meeting may each be defined through a pre-established classification system for distinguishing the scope to which the meeting belongs. In one embodiment, the information for each classification system may be read from memory 110 and can be generated or updated by an administrator account or a user account. In one embodiment, each classification system may correspond to at least one of a plurality of predetermined candidate classification systems, which is selected by the host terminal 200.

For example, in order to receive a meeting request containing the meeting classification information 14, the information for the meeting host, the meeting participants, the department name, the project name, the specific work or task from the workflow, and the technical field is provided to the host terminal 200, and one of the provided pieces of information (e.g., project name) may be selected by the host terminal 200. Further, information about multiple candidate classification systems (e.g., Project Classification System 1, Project Classification System 2, etc.) for the selected piece of information (e.g., project name) is provided to the host terminal 200, and one of the candidate classification systems (e.g., Project Classification System 2) may be selected by the host terminal 200.

In one embodiment, each of the aforementioned classification systems may include a plurality of levels having a hierarchical structure (e.g., a form where a higher-level encompasses lower levels) and/or a sequential structure (e.g., a form where the chronological order between a preceding level and a succeeding level is distinguished).

For example, the classification system for the meeting host, the meeting participants, and the department name may include a plurality of levels corresponding to a plurality of user accounts or a plurality of levels corresponding to user groups formed by grouping user accounts (e.g., company name, department name). Alternatively, it may include a plurality of higher levels corresponding to a plurality of first user groups (e.g., company name, upper-level department name) and a plurality of lower levels corresponding to a plurality of second user groups (e.g., department name, lower-level department name) belonging to each first group or a plurality of user accounts. Furthermore, the classification system for the project name may include a plurality of higher levels corresponding to a plurality of project names and a plurality of lower levels corresponding to a plurality of tasks for each project (or a plurality of sub-projects belonging to each project). Further, the classification system for the workflow, which includes a plurality of works according to a sequence of tasks or procedures, may include a plurality of higher levels corresponding to a plurality of works and a plurality of lower levels corresponding to a plurality of tasks for each work. Moreover, the classification system for the technical classification may include a plurality of higher levels corresponding to a plurality of upper-level technical classifications and a plurality of lower levels corresponding to a plurality of sub-technical classifications belonging to each upper-level technical classification.

In the example described above, the meeting classification information 14 may include at least one level from among the plurality of levels in each of the aforementioned classification systems. For example, the host terminal 200 may select one of the meeting host, the meeting participants, the department names, the project names, the specific tasks or workflows in the work process, and the technical fields from the classification systems. Once one classification system is selected, information related to that classification system is provided to the host terminal 200. The meeting classification information 14 that is received may include selection information from the host terminal 200 regarding one of the plurality of higher levels (e.g., a plurality of project names) in the selected classification system and/or one of a plurality of lower levels (e.g., a plurality of task names) belonging to the selected higher level.

As another specific example, the classification information of a past meeting conducted prior to the current meeting may include the linking relationship between the current meeting and the past meeting, as well as the meeting identifier of the past meeting (e.g., meeting ID).

The linking relationship may include, for example, a first linking relationship indicating that the current meeting is directly connected to the past meeting (e.g., the meeting content is substantially the same and is a continuation of the past meeting) and a second linking relationship indicating that the current meeting is indirectly connected to the past meeting (e.g., the content of the meeting is at least partially different but the meeting is derived from the past meeting)

In one embodiment, the meeting classification information 14 may be obtained from the meeting information 10 included in the meeting request. That is, the meeting classification information 14 is not obtained during the process of receiving the meeting request, but can be derived through analysis of the information elements included in the meeting request. For example, the meeting information acquisition unit 111 may perform text mining on the texts included in the meeting content 12 using a pre-stored text classification algorithm (e.g., a neural network-based text classification), and the meeting classification information 14 can be obtained by classifying the meeting into an appropriate category based on the result of the text mining. In another example, the meeting information acquisition unit 111 may acquire values corresponding to a plurality of metadata items from the meeting information 10, and use the acquired metadata values to obtain the meeting classification information 14. Metadata will be explained in more detail later.

In one embodiment, the meeting information 10 may further include a meeting title, which more concisely represents the meeting, the meeting objectives, which indicate the outcomes sought or achievable through the meeting, an introduction to the meeting host, or an introduction to the user group (e.g., company, department) to which the meeting host belongs. The aforementioned meeting information is just an example, and various other types of information that are typically used during the meeting process may also be included. Additionally, in one embodiment, some of the meeting information 10 is acquired during the process of receiving the meeting request, while the rest may be obtained in subsequent processes.

In one embodiment, the meeting information acquisition unit 111, during the process of receiving the meeting request, may recommend a list of potential meeting participants to the host terminal 200 based on the meeting content 12 and/or the meeting classification information 14. For example, when the meeting classification information 14 is received during the process of receiving the meeting request, the meeting information acquisition unit 111 searches for user accounts that have a history of participating in past meetings corresponding at least partially to the received meeting classification information 14, from a pre-stored list of a plurality of user accounts, and then recommends those user accounts that meet predetermined recommendation criteria as potential meeting participants. The aforementioned recommendation criteria may include, for example, users who belong to the same company or department as the meeting host, or those who have a history of participating in the same meeting.

In one embodiment, the meeting information acquisition unit 111 may receive, from the host terminal, user input for a plurality of meeting participants including the recommended candidate meeting participants, and determine the meeting participants of the meeting based on the user input. For example, an input menu where the user accounts for potential meeting participants may be displayed on the host terminal 200, and an identifiable indication for the candidate participants may be provided in the input menu. The meeting information acquisition unit 111 may determine the user accounts selected by the host terminal 200 through the input menu as meeting participants.

The meeting information acquisition unit 111 may check the participation responses for the meeting requests from each meeting participant based on the meeting participants' information 13. In one embodiment, the meeting information acquisition unit 111 sends an invitation message including the meeting duration 11 and meeting content 12 to each participant terminal 300, and may check whether a participation response corresponding to the invitation message is received from each participant terminal 300. In one embodiment, the invitation message may further include information about the meeting host and/or the meeting participants' information 13.

In one embodiment, the invitation message may be provided through at least one of SMS (Short Message Service), (Long Message Service), and MMS (Multimedia Message Service). For example, the meeting information acquisition unit 111 may send an invitation message to a mobile carrier server connected to the meeting service device 100 via a network, so that a text message containing the invitation message is sent to participant terminals 300 corresponding to mobile carrier subscribers through the mobile carrier network connected to the mobile carrier server.

In another embodiment, the invitation message may be provided to the user account of each meeting participant. For example, the meeting information acquisition unit 111 may send the invitation message to the message inbox of the user account through the message service provided by the meeting service application, or it can be provided in the form of a pop-up message on the participant terminal 300 of the user account.

In still another embodiment, the invitation message may be a message provided through a messaging application. For example, the meeting information acquisition unit 111 may send the invitation message to a message service server (not shown) connected to the meeting service device 100 via a network, so that an app text message containing the invitation message is sent to participant terminals 300 corresponding to messaging application subscribers through the messaging application.

The meeting information acquisition unit 111 may determine that the participation response to the meeting request of the participant has been confirmed when an acceptance response corresponding to the invitation message is received from the participant terminal 300. Similarly, the meeting information acquisition unit 111 may determine that the rejection response to the meeting request of the participant has been confirmed when a rejection response corresponding to the invitation message is received from the participant terminal 300. According to the above-described embodiments, the method of providing the invitation message (e.g., mobile phone text message, app text message) and the method of confirming the participation or rejection response (e.g., app text message) may be the same or different.

The meeting information acquisition unit 111 may determine whether the meeting request is approved based on the participation responses to the meeting requests from each meeting participant. In one embodiment, the meeting information acquisition unit 111 may approve the meeting request when participation responses corresponding to the invitation message are received from M participants (where M is a natural number) within a predetermined period, among the meeting participants. As an example, M may be 2 or more. In another example, M may be determined based on the number of meeting participants, and, for instance, may be set so that more than half of the total number of participants or a predetermined ratio is reached.

In one embodiment, the predetermined period may be set based on the start time of the meeting duration 11 and/or the time the invitation message is provided. For example, the predetermined period may be set by the meeting host within a predetermined time interval (e.g., 24 hours, 3 days) relative to the start time of the meeting duration 11 or the time the invitation message is provided, and may be extended or renewed at the request of a meeting participant.

In one embodiment, when the meeting request is approved, the meeting information acquisition unit 111 may provide a first approval message to the host terminal 200 and/or the participant terminals 300 of the meeting participants for whom the participation response has been confirmed. In one embodiment, the first approval message may include a message notifying the approval of the meeting request and/or information about the meeting participants for whom the participation response has been confirmed (e.g., names, number of participants).

In one embodiment, when the meeting request is approved, the meeting information acquisition unit 111 may provide a second approval message to the participant terminals 300 of the meeting participants for whom the participation response has not been confirmed. In one embodiment, the second approval message may include the deadline for the participation response to the invitation message, the invitation message, and the first approval message. In one embodiment, these approval messages may be provided in a manner similar to the providing method of the aforementioned invitation message.

In one embodiment, if the participation responses from M or more participants are not received within the predetermined deadline, the meeting information acquisition unit 111 may reject the meeting request. Similarly, if the meeting request is rejected, a rejection message corresponding to the rejection may be provided to the host terminal 200 and/or the participant terminals 300.

The meeting information acquisition unit 111 may obtain video data. Here, the video data refers to video content associated with the meeting content 12, which could be a video explaining the contents to be discussed in the meeting, but it is not limited thereto. For example, the video data could be a recorded video where the meeting host explains presentation materials related to the meeting agenda, or it could be a simulation video of technical content related to the meeting topic. Alternatively, the video data might be reference videos about potential topics to be covered in the meeting, or it could be videos or links to videos for ideation, icebreaking, or other activities that are not directly related to the meeting content 12.

The video data according to one embodiment refers to data corresponding to a preset video format, and may include data corresponding to any known file format typically used to store digital video data in a conventional computing environment. However, the video data of the present disclosure is not limited thereto, and depending on the embodiment, it may refer to image data corresponding to a preset image format or may be understood as a concept that encompasses the image data.

In one embodiment, the meeting information acquisition unit 111 may obtain video data from the host terminal 200 or from another user's terminal (not shown) designated by the host terminal 200. The aforementioned other user's terminal refers, for example, to a user terminal corresponding to one of the user accounts using the meeting service, to which the meeting host has granted video upload permissions for the meeting. As an example, this could be the participant terminal 300 of one of the meeting participants, or a user terminal unrelated to the meeting participants.

In one embodiment, the meeting information acquisition unit 111 may obtain video data from the host terminal 200 (or from the terminal of another user as mentioned above). For example, the video data may be prepared by the host's filming operation, and the meeting information acquisition unit 111 may receive the video data from the host terminal 200.

In another embodiment, the meeting information acquisition unit 111 may generate video data based on data received through interaction with the host terminal 200 (or the terminal of another user as mentioned above) when a video generation request is received from the host terminal 200. For example, the host terminal 200 may send a video generation request to the communication unit 120 through the installed meeting service application, and the meeting information acquisition unit 111 may, in response to the video generation request, interact with the host terminal 200 through the meeting service application and control the host terminal 200 to perform video recording. Additionally, the communication unit 120 may receive real-time, periodic, or batch video input from the host terminal 200 during the video recording process, and the meeting information acquisition unit 111 may perform video compression and video control operations on the received video input, thereby generating video data in a preconfigured video format.

In another embodiment, the meeting information acquisition unit 111 may obtain video data from a meeting request when the meeting request includes video data. For example, the meeting request or the meeting content 12 may include video data, and the meeting information acquisition unit 111 may extract video data from the meeting request or the meeting content 12.

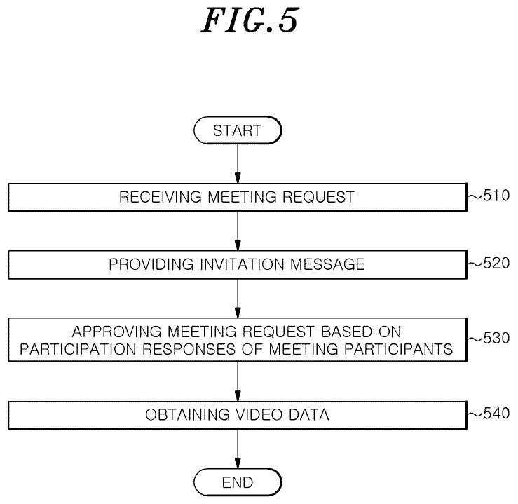

Meanwhile, the process of acquiring video data according to one embodiment may be performed either before the reception of the meeting request, during the reception process of the meeting request, or after the reception of the meeting request. Further, in connection with this process, the approval process for the meeting request based on the provision of the invitation message and participation response, as described above, may be performed. Embodiments related thereto will be further explained with reference to FIGS. 5 to 7.

FIG. 5 illustratively shows a flowchart of the process of obtaining video data according to a first embodiment. Referring to FIG. 5, the video data can be acquired after the approval of the meeting request. Explanations that are redundant with the embodiments described above will be omitted.

In step S510, the meeting information acquisition unit 111 may receive a meeting request from the host terminal 200. For example, the meeting information acquisition unit 111 may receive a meeting request that includes information on at least three participants 13, meeting duration 11, and meeting content 12 through the communication unit 120.

In step S520, the meeting information acquisition unit 111 may provide an invitation message to each participant terminal 300 of the meeting participants. For example, the meeting information acquisition unit 111 may send an invitation message containing the meeting duration 11 and the meeting content 12 to each participant terminal 300 of at least three participants through the communication unit 120.

In step S530, the meeting information acquisition unit 111 may approve the meeting request based on the participation responses of the meeting participants. For example, the meeting information acquisition unit 111 may approve the meeting request when participation responses corresponding to the invitation messages of at least two participants are confirmed, and provide an approval message corresponding to the approval to the host terminal 200.

In step S540, the meeting information acquisition unit 111 may obtain video data in response to the approval of the meeting request. For example, when the meeting request is approved, the meeting information acquisition unit 111 may send a message requesting the provision of video data to the host terminal 200, or control the host terminal 200 to allow video uploading, thereby receiving video data from the host terminal 200 according to the aforementioned embodiments.

According to the first embodiment, the step of acquiring video data may be performed in response to the approval of the meeting request. Accordingly, when the meeting creation is confirmed upon the acceptance of the meeting invitation by the minimum required number of participants, an environment in which the video data, which serves as the main medium in the meeting, can be registered may be provided to the meeting host.

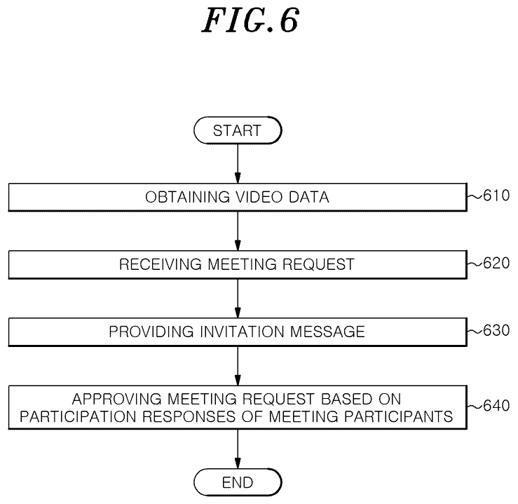

FIG. 6 illustrates an exemplary flowchart of the process for obtaining video data according to the second embodiment. Referring to FIG. 6, the video data may be acquired prior to the reception of the meeting request.

In step S610, the meeting information acquisition unit 111 may obtain video data. For example, the meeting information acquisition unit 111 may receive a request for video upload related to the generation of a meeting from the host terminal 200, and in response to this request, the meeting information acquisition unit 111 may receive video data prepared by the meeting host's recording operations, etc.

In step S620, the meeting information acquisition unit 111 may receive a meeting request from the host terminal 200. For example, once the video data is acquired, the meeting information acquisition unit 111 may request the host terminal 200 to provide information for creating the meeting, and receive the meeting request from the host terminal 200.

In step S630, the meeting information acquisition unit 111 may provide an invitation message to each participant terminal 300 of the meeting participants.

In step S640, the meeting information acquisition unit 111 may approve the meeting request based on the participation responses of the meeting participants.

According to the second embodiment, the step of acquiring video data may be performed prior to the step of receiving the meeting request in response to a request from the host terminal 200. As a result, an environment for registering the video data, which serves as the main medium in the meeting, can be provided to the meeting host before other processes.

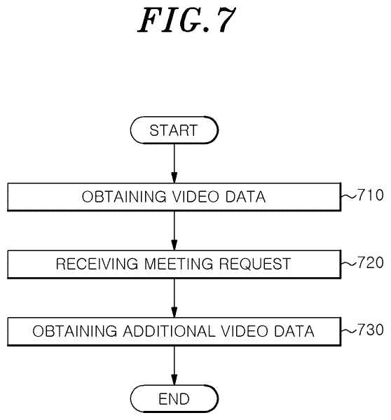

FIG. 7 illustrates an exemplary flowchart of the process for obtaining video data according to a third embodiment. Referring to FIG. 7, one or more video data may be acquired before or after the reception of the meeting request.

In step S710, the meeting information acquisition unit 111 may obtain video data. For example, the meeting information acquisition unit 111 may receive a first video data (e.g., an intro video) related to the generation of the meeting from the host terminal 200 or from another terminal designated by the host terminal 200.

In step S720, the meeting information acquisition unit 111 may receive a meeting request from the host terminal 200. Depending on the implementation example, steps S710 and S720 may be performed together, or step S710 may be performed after step S720. In the third embodiment, the meeting information acquisition unit 111 may provide video data and an invitation message to each participant terminal 300 of the meeting participants. For example, the meeting information acquisition unit 111 may send an invitation message, which further includes an access link for accessing the first video data, to each participant terminal 300 of the meeting participants.

In step S730, the meeting information acquisition unit 111 may obtain one or more additional video data. For example, the meeting information acquisition unit 111 may receive, as additional video data, a second video data (e.g., main video) from the host terminal 200, the participant terminal 300, or a terminal of another user designated by the host terminal 200. In the third embodiment, such additional video data may be acquired either before the meeting begins (e.g., before the start time of the meeting duration 11), during the meeting, or through methods such as recording, as described in the aforementioned embodiments.

According to the third embodiment, the step of acquiring additional video data may be performed after receiving the meeting request. As a result, during the meeting invitation process, the acceptance rate of the meeting invitation and the participants' prior understanding of the meeting content 12 can be improved through the intro video. During the meeting process, the meeting can proceed more effectively with a more polished main video.

According to one embodiment of the present disclosure, the meeting room provision unit 112 can be implemented to provide an online meeting room 20 based on the meeting request. Here, the online meeting room 20 may correspond to the meeting and may be understood as a concept that includes a data space allocated for storing and managing data related to the meeting, however, it is not limited thereto. The online meeting room 20 in one embodiment may be understood as a concept encompassing the meeting environment for providing an online meeting space through the data stored in the aforementioned data space. Therefore, providing the online meeting room 20 may include, for example, providing data included in the online meeting room 20 to the participant terminal 300, or in another example, it may be understood as encompassing the implementation of the online meeting space on the participant terminal 300 using the data.

Specifically, the meeting room provision unit 112 may generate an online meeting room 20 based on the meeting request. For example, the meeting room provision unit 112 may generate a meeting identifier (e.g., a meeting ID) corresponding to the meeting request, and then generate an online meeting room 20 corresponding to the meeting identifier to store and manage the online meeting room 20 in the database 400. The database 400 may already store and manage information about a plurality of online meeting rooms 20, each corresponding to a plurality of meeting identifiers, which were generated prior to the generation of the aforementioned online meeting room 20. The plurality of online meeting rooms 20 may have been acquired in the same or similar manner as described throughout the specification.

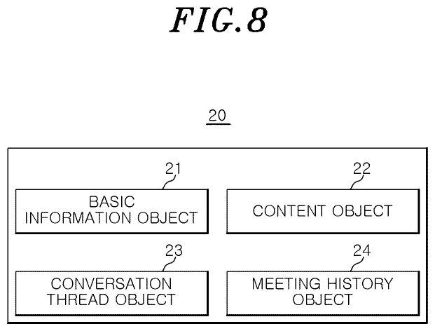

The generation of the online meeting room 20 according to one embodiment may be understood as a concept corresponding to the generation of a meeting. The details thereof will be explained with reference to FIG. 8.

FIG. 8 schematically illustrates the block diagram of the online meeting room 20 according to one embodiment.

Referring to FIG. 8, the online meeting room 20 may include at least one of the group consisting of a basic information object 21, a content object 22, a conversation thread object 23, and a meeting history object 24. Here, an object refers to a processing unit for each component included in the online meeting room 20. In one embodiment, each object corresponds to a logical storage unit where the data is stored and may be allocated to different storage spaces within the online meeting room 20, however, it is not limited thereto. For example, each object is one of the components of the online meeting room 20, but actions such as viewing, deleting, inputting, or modifying by an authorized user may be independently processed through one of the components of another online meeting room 20.

The basic information object 21 may include meeting information 10. For example, the basic information object 21 may include the meeting duration 11, meeting content 12, information about the meeting host, information about the meeting participants 13, and meeting classification information 14, all of which are included in the meeting request, and it may further include a meeting title or meeting objectives, or the like. In one embodiment, the basic information object 21 may further include information generated during the meeting process, such as announcements or reference materials registered by the meeting host or participants, and meeting minutes summarizing the progress or results of the meeting.

The content object 22 may include the obtained video data. For example, the content object 22 may include video data associated with the aforementioned meeting content 12 and may further include additional video data.

The conversation thread object 23 may include one or more conversation threads. Here, the conversation thread refers to a unit of conversation that can include a plurality of conversations initiated by meeting participants. In one embodiment, the conversation thread may be understood as a concept encompassing a workspace for sequentially processing a plurality of conversations generated by meeting participants. For example, it may be provided in the form of a chat room through mechanisms such as message queues and handlers. Further, a conversation represents a unit of processing within the thread and, in one embodiment, may be based on at least one input from meeting participants, such as text, images, video, or audio. For instance, each conversation could be a message based on text input or a message based on image, video, or audio input.

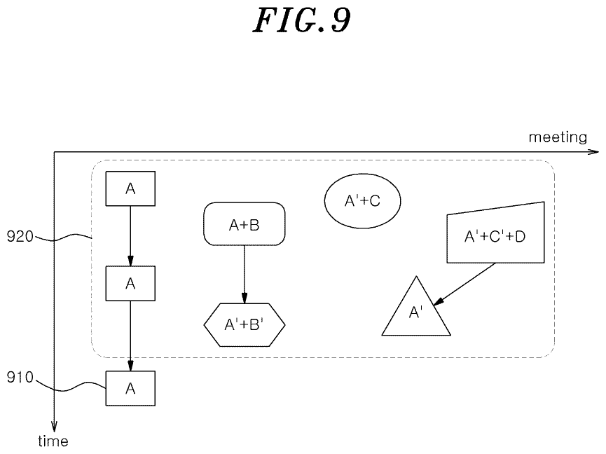

The meeting history object 24 may represent a historical relationship between the corresponding online meeting room 20 and one or more other online meeting rooms 20 associated with the online meeting room 20. For example, the meeting history object 24 of a first online meeting room may include information regarding the historical relationship between the first online meeting room and one or more second online meeting rooms that have meeting information similar to or associated with the first online meeting room at a predetermined level or higher. To achieve this, the historical relationship described above may be analyzed from the database 400, which stores a plurality of online meeting rooms 20, by the meeting room provision unit 112. Based on the analysis results, the meeting history object 24 containing information about the historical relationship may be generated or updated. Details regarding the meeting history object 24 will be explained in more detail with reference to FIGS. 9 to 13.

FIG. 9 illustratively depicts a diagram explaining the concept of the meeting history object 24 according to one embodiment.

First, consider a situation in which there is a target meeting 910 with meeting content 12 labeled as “A,” but history information about other past meetings is not provided, as in conventional technology. According to such conventional technology, participants in the target meeting 910 face challenges in knowing whether other similar past meetings have taken place. Participants may have partial knowledge of the history of past meetings directly related to the target meeting 910 (e.g., several meetings on the same topic held within the same department). However, the level of understanding may vary significantly depending on individual experience. Furthermore, the participants are likely unaware of the history of past meetings not directly related to the target meeting 910 (e.g., meetings with similar or slightly different topics held in other departments). Consequently, the participants are limited to understanding the history of similar past meetings only within the scope of their individual meeting experiences.

However, referring to FIG. 9, as history information about other past meetings aside from the target meeting 910, relationships 920 between the target meeting 910 and one or more associated meetings may be provided according to one embodiment of the present disclosure. These relationships 920 may include information on how each past meeting is related to the target meeting 910 in certain aspects (e.g., as meeting information such as meeting content 12, meeting topics, or technical fields) and the type of connection shared with the target meeting 910 (e.g., direct connection meetings, indirect connection meetings, or derivative meetings).

For example, the aforementioned relationships 920 may provide information about two past meetings whose meeting contents 12 are identical to “A” of the target meeting 910 and are connected to the target meeting 910. Additionally, the relationships 920 may include information on a plurality of past meetings that are not directly connected to the target meeting 910 but whose meeting contents 12 include “A” or are partially similar to “A,” such as variations “A′,” or “A″”. In the relationships 920, the information about past meetings may be sequentially listed in chronological order based on the meeting period 11 (e.g., start time) of each meeting. As a result, the participants in the meeting may intuitively understand the time-series history of relationships between the target meeting 910 and related past meetings without being limited by their individual meeting experiences. This enables the meeting participants to gain a better understanding of the discussions and conclusions from similar past meetings, thereby facilitating more effective meeting progress.

In one embodiment, the meeting history object 24 may visualize to provide the sequential and/or hierarchical historical relationship of meetings prior to the generation of the online meeting room 20 based on the meeting classification information 14. For example, the meeting history object 24 may include the chronological and/or hierarchical relationships of meetings based on at least one of the meeting host, meeting participants, department name, project name, specific work or task in the workflow, technical fields, and any past meetings held prior to the current meeting as included in the meeting classification information 14.

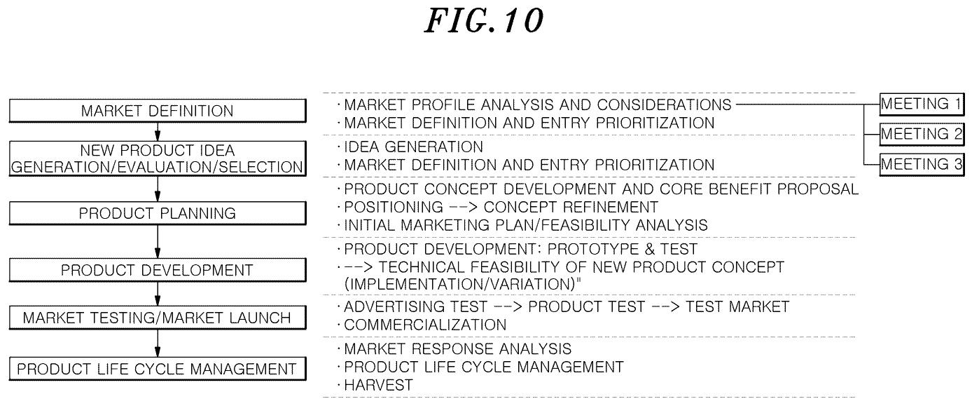

FIG. 10 is a diagram illustrating the meeting history object 24 associated with a project according to one embodiment. Referring to FIG. 10, the meeting history object 24 may include the hierarchical relationships of meetings based on the project name classification information. For example, when a classification system defining a project is used in the meeting classification information 14, the meeting history object 24 may include information about meetings corresponding to each level in the classification system that defines the project (e.g., meeting title, meeting link, etc.).

FIG. 10 illustrates a typical process used in a product development project as an example of the classification system defining the project. The classification system for such a project may have a complex structure, where a plurality of works (e.g., market definition, new product idea generation/evaluation/selection, etc.) are sequentially linked, and each work (e.g., market definition) is further connected to a plurality of hierarchical tasks (e.g., market profile analysis and considerations). The meeting history object 24 may include a list of meetings that have classification information corresponding to each level or belonging to each level of the classification system, selected from the plurality of online meeting rooms 20 stored in the database 400. Additionally, the meeting history object 24 may include identifiable information about the level of the current meeting within the classification system (e.g., Meeting 2).

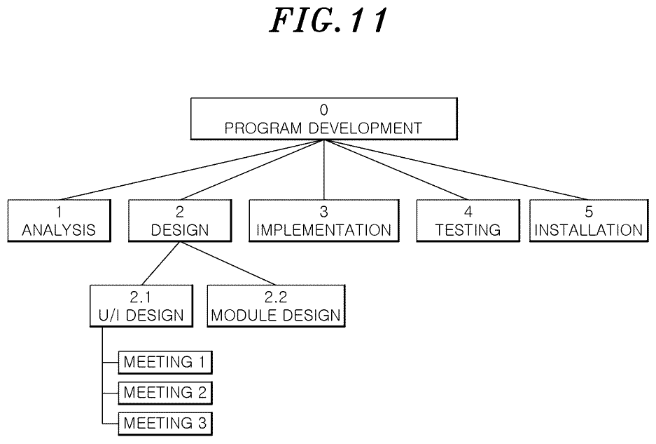

FIG. 11 illustrates the meeting history object 24 associated with a project according to another embodiment. The classification system for such a project may have a structure where tasks, such as analysis and design, are child nodes under the top-level node (e.g., program development), forming a tree structure.

In a manner similar to what has been described, the meeting history objects 24 associated with workflows, technical fields, departments, meeting hosts, and meeting participants may be provided. For example, the meeting history object 24 associated with the workflow may include the hierarchical relationships of meetings based on the classification information of the workflow, which defines the sequence of works for handling a specific task. Alternatively, the meeting history object 24 associated with the technical field may include the hierarchical relationships of meetings based on the classification information of the technical field, where various technical categories are divided into major, middle, and subcategories. Additionally, the meeting history object 24 associated with the meeting host (or the participant) may include the hierarchical relationships of meetings based on the classification information of organization members, where the organizational chart of a user group (e.g., a company) is divided into major, middle, and subcategories.

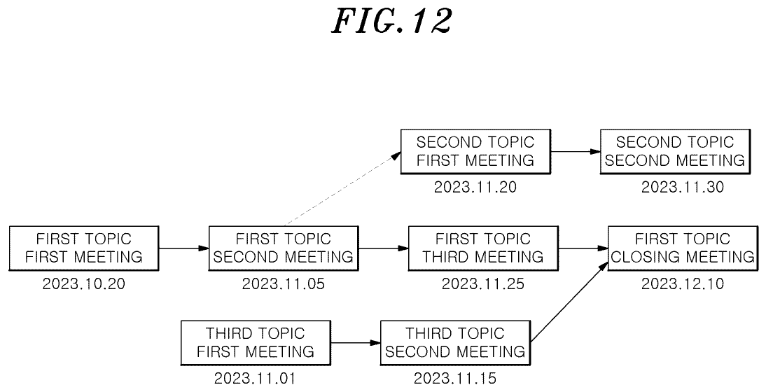

FIG. 12 illustrates the meeting history object 24 associated with past meetings performed prior to the current meeting, according to one embodiment. Referring to FIG. 12, the meeting history object 24 may include the chronological relationships of meetings based on the classification information of past meetings performed before the current meeting. In one embodiment, the past meetings performed before the current meeting may include meetings that are directly or indirectly connected to the current meeting. For example, if the meeting classification information 14 includes information about past meetings connected to the current meeting (e.g., meeting identifiers, connection relationships), the meeting history object 24 may include the chronological relationships of meetings based on the meeting classification information 14 of the current meeting and the past meetings, analyzed according to a predetermined timeline.

As an example, if the meeting classification information 14 of a first online meeting room, corresponding to a second topic's secondary meeting, records the first meeting of the second topic as a past meeting with a first connection relationship, performed immediately prior to the current meeting, the meeting classification information 14 of the first meeting of the second topic, along with the meeting classification information 14 of the past meetings derived from the first meeting of the second topic, may be comprehensively considered. In this case, information regarding the sequential relationships, continuity, and/or derivation of numerous meetings that took place prior to the secondary meeting of the second topic may be included in the meeting history object 24.

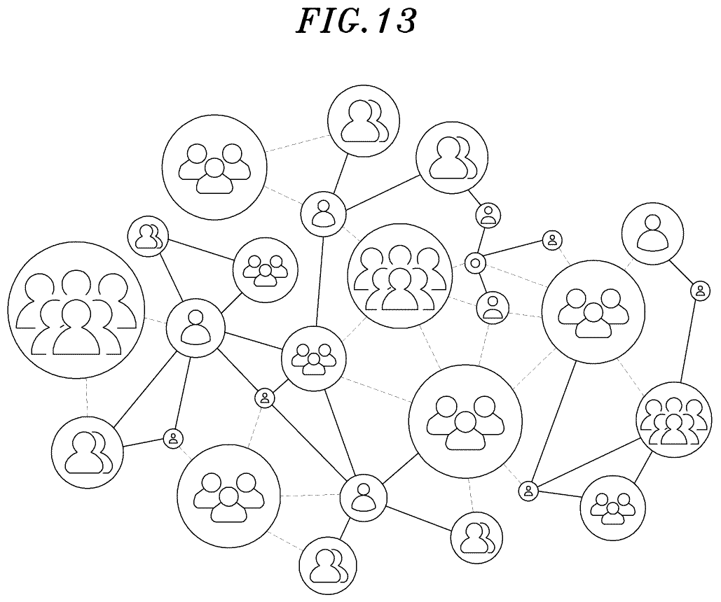

FIG. 13 illustrates the meeting history object 24 associated with meeting participants according to one embodiment. Referring to FIG. 13, the meeting history object 24 may represent the interrelationships between meetings based on classification information in the form of a network structure. In one embodiment, the meeting history object 24 may visualize the interrelationships between meetings in a network by using nodes representing each meeting and links connecting the nodes. Each meeting may be linked through a connection to other meetings whose meeting classification information 14 at least partially overlaps.

As an example, in the network structure, each meeting may be connected through links to other meetings whose members, including the meeting hosts and meeting participants from a user group, are at least partially overlapping. Additionally, the thickness or length of each link connecting the meetings may be varied to visually represent the degree of connection between meetings, making the connection intuitively understandable. Moreover, by varying the type of icon representing each node, the size of the image, the shape of each link (e.g., solid line, dashed line), or the color of each node, the scale of each meeting can be visualized, or the interrelated classification information (e.g., technical classification, project, direct connection relationship) of the two meetings represented by the link can be made identifiable. Similarly, the relationships depicted above are merely examples and can be modified and implemented in various forms.

In one embodiment, the meeting history object 24 may include (i) a history chart representing the visualization of the relationships mentioned above, (ii) meeting minutes summarizing the results of one or more other online meeting rooms 20 associated with the online meeting room 20, and (iii) at least one access link for each of the aforementioned other online meeting rooms 20. For example, the meeting history object 24 may include the history chart, such as those depicted in FIGS. 9 to 13, where the relationships of past meetings are processed in the form of an image or table. Further, a link for accessing the online meeting room 20 corresponding to each past meeting in the list of past meetings included in the history chart can be mapped to allow a device to access the meeting or meeting minutes through the link.

The process of generating the online meeting room 20 according to one embodiment may be performed in response to the approval of a meeting request, but is not limited thereto. For example, the online meeting room 20 may be generated in response to the approval of the meeting request. Alternatively, the online meeting room 20 may be generated as the meeting request or video data is obtained, and then stored and managed in the database 400 in response to the approval of the meeting request, or deleted in response to the rejection of the meeting request.

The meeting room provision unit 112 may provide the online meeting room 20 to each participant terminal 300 of the meeting participants through the network. For example, when the meeting request is approved, the meeting room provision unit 112 may provide the information included in the online meeting room 20 to the participant terminals 300 that connect to the online meeting room 20. In one embodiment, providing the online meeting room 20 may be understood as providing the information included in the online meeting room 20 and/or providing a meeting environment for users to utilize that information. For example, the meeting room provision unit 112 may provide meeting information through the basic information object 21, offer a multimedia environment through the content object 22 that allows each meeting participant to watch videos at any time, provide a conversation environment (e.g., a chat room) through the conversation thread object 23 for meeting participants to exchange opinions, and provide historical information about the relationships of other past meetings associated with the current meeting through the meeting history object 24.

The meeting room provision unit 112 may provide the online meeting room 20 to each participant terminal 300 through the network in response to a request from each participant terminal 300 of the meeting participants during the meeting duration 11, allowing the meeting to proceed with non-real-time participation by the meeting participants. For example, the host terminal 200 or each participant terminal 300 may request access to the online meeting room 20 from the meeting room provision unit 112 at any time during the meeting duration 11 through the meeting service application. The meeting room provision unit 112 may control the progress of the meeting by providing the online meeting room 20 to the corresponding terminal whenever access is requested.

The provision of the online meeting room 20 according to one embodiment may be performed regardless of the current location of the participant terminal 300, the connection time, or whether other meeting participants are currently connected. For example, even if each participant terminal 300 is located remotely from one another, requests are made for access at late hours, or no users are currently connected to the online meeting room 20, the online meeting room 20 may be provided in response to such access requests by the meeting room provision unit 112, irrespective of these factors.

As a result, the meeting can proceed with non-real-time participation from the meeting participants. The meeting host and participants can join the online meeting room 20 at their desired time and location to watch the video or asynchronously exchange opinions on the meeting agenda presented in the video via the chat room, thus participating in the meeting in a non-real-time manner.

The meeting room provision unit 112 may control the host terminal 200 and/or the participant terminal 300 connected to the online meeting room 20 during the meeting duration 11, ensuring they are connected through the meeting service application. As a result, each meeting participant can join the meeting non-real-time at their desired time, while simultaneously communicating in real-time with other participants who are connected to the online meeting room 20 through the chat room.

In one embodiment, the meeting room provision unit 112 may provide the online meeting room 20 to each participant terminal 300 of the meeting participants whose participation response for the online meeting room 20 has been confirmed. For example, the meeting room provision unit 112 may provide the online meeting room 20 only to the participant terminals 300 for which a participation response has been confirmed, by transmitting the invitation acceptance response corresponding to the aforementioned invitation message.

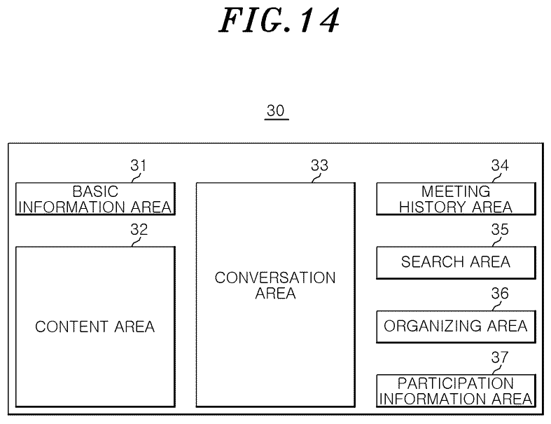

In the process of providing the aforementioned online meeting room 20, the information of the online meeting room 20 may be displayed on the host terminal 200 or each participant terminal 300. The details regarding thereof will be explained with reference to FIG. 14.

FIG. 14 is an exemplary diagram illustrating the display of the information of the online meeting room 20 on the screen of the host terminal 200 and/or the participant terminal 300 according to one embodiment.

Referring to FIG. 14, the meeting room provision unit 112 may cause an online meeting room screen 30, which includes information about the online meeting room 20, to be displayed on the host terminal 200 or the participant terminal 300. For example, in response to a connection request for the online meeting room 20 from each participant terminal 300, the meeting room provision unit 112 may transmit information about the online meeting room 20 to the corresponding participant terminal 300, and control the transmitted information to be displayed on the online meeting room screen 30 through the meeting service application of the participant terminal 300.

The online meeting room screen 30 according to one embodiment may include at least one of a basic information area 31 corresponding to the basic information object 21, a content area 32 corresponding to the content object 22, a conversation area 33 corresponding to the conversation thread object 23, and a meeting history area 34 corresponding to the meeting history object 24. Depending on the implementation, the basic information area 31, the content area 32, the conversation area 33, and the meeting history area 34 may also be understood as interchangeable concepts with the basic information object 21, the content object 22, the conversation thread object 23, and the meeting history object 24, respectively.

The basic information object 21 may provide meeting information to the basic information area 31. For example, the basic information area 31 may display at least some of meeting duration 11, meeting content 12, information about the meeting participants 13, and meeting classification information 14 from the basic information object 21.

In one embodiment, the basic information object 21 may be updated at least partially based on the input from the participant terminal 300 regarding the meeting information provided through the basic information area 31. For example, the meeting room provision unit 112 may receive input from the participant terminal 300 regarding the meeting classification information 14 displayed in the basic information area 31, and based on the received input, the basic information object 21 may be updated. In one embodiment, the input from the participant terminal 300 regarding the meeting classification information 14 may be restricted. For instance, it may be allowed only in a limited manner, such as when additional classification information not included in the meeting classification information 14 of the basic information object 21 is added (e.g., adding the relevant level), based on the settings by the meeting host. For example, since the meeting classification information 14 may vary depending on the user experience of the meeting, it can be acquired not only during the meeting creation process by the meeting host but also during the meeting progress by the participants.

The content object 22 may provide video data to the content area 32. For example, in response to a user input for viewing the video, video data may be displayed in the content area 32 using a multimedia player that can play the video.

The conversation thread object 23 may provide conversations and/or the conversation environment to the conversation area 33. For example, in the conversation area 33, the conversations of the meeting participants may be displayed based on a chat room implemented to allow participants to exchange their opinions.

The meeting history object 24 may provide the relationship between the current online meeting room 20 and one or more other online meeting rooms 20 in the meeting history area 34. For example, in the meeting history area 34, the chronological and/or hierarchical relationships of meetings prior to the generation of the online meeting room 20, based on the meeting classification information 14, may be visualized and provided.

In one example, as described above with reference to FIG. 10, in the meeting history area 34, the hierarchical relationships of other past meetings associated with the current meeting may be visualized by project. To achieve this, the meeting room provision unit 112 may search for past meetings associated with the current meeting in relation to the project, among the multiple online meeting rooms 20 stored in the database 400, based on the project name classification information included in the basic information object 21. The meeting room provision unit 112 may then include the results of analyzing the hierarchical relationships between the current meeting and the past meetings in the meeting history object 24. As a result, as the hierarchical relationship, a history chart visualizing the information of the meetings at each level within the classification system may be displayed in the meeting history area 34. Further, through the history chart, meeting information, an access link, and a meeting minutes link for each level's meeting may be provided, and an identifiable indication showing the level of the current meeting within the classification system may also be displayed.

In another example, as described above with reference to FIG. 11, in the meeting history area 34, the meeting history area 34 may visually present the chronological relationships of past meetings that were held prior to the current meeting. To achieve this, the meeting room provision unit 112 may search for past meetings based on classification information (e.g., meeting identifier, connection relationship) of the past meetings performed before the current meeting, which is included in the basic information object 21 of the current meeting. This search is carried out by repeating the process of searching for the relevant past meetings from a plurality of online meeting rooms 20 stored in the database 400, and then searching for past meetings of these past meetings based on the meeting classification information 14 of each past meeting. In this way, past meetings directly or indirectly related to the current meeting can be identified. Further, the meeting room provision unit 112 may include the result of analyzing the chronological relationships between the current meeting and the searched past meetings in the meeting history object 24. Consequently, in the meeting history area 34, a historical chart visualizing the information of past meetings directly or indirectly connected to the current meeting in chronological order, based on the meeting duration 11, may be displayed. Furthermore, through the history chart, meeting information, access links, and meeting minutes links for each meeting may be provided, along with identifiable indicators showing the sequence (e.g., batch order) of the meetings, types of connection relationships (e.g., direct connection, indirect connection, derivative connection), and an identifiable indicator showing which meeting in the history chart is the current meeting.

In a similar manner as described above, the meeting history area 34 may visually present the relationships of other past meetings related to the current meeting, organized by workflow, technical field, department, meeting host, and meeting participants. Meanwhile, as means for visually expressing these relationships, various universal representation methods such as flowcharts, diagrams, block diagrams, or multidimensional charts (e.g., images, graphs, matrices) may be used. However, these are not limited to the forms exemplified above. Furthermore, various universal algorithms required for image processing or graphic processing may be included in the meeting room provision unit 112.

Meanwhile, in one embodiment, the meeting history object 24 may be updated by the meeting room provision unit 112 during the process of providing the aforementioned relationships. As a result, in the meeting history area 34, the relationships between the current meeting and the past meetings, either updated based on the point in time when the relationship provision is required or the most recently updated ones, may be provided. In one embodiment, the aforementioned relationships may be provided through the online meeting room screen 30 during the process of providing the online meeting room 20. In another embodiment, the relationships may be provided through the online meeting room screen 30 or a separate screen in response to a history provision request by the user.

In one embodiment, the meeting history object 24 may provide the aforementioned relationships in the meeting history area 34 in response to user input corresponding to at least one of the plurality of classification information items included in the meeting classification information 14. For example, the meeting history object 24 may include a first relationship for meetings by the meeting host, a second relationship for meetings by the meeting participant, a third relationship for meetings by the department, a fourth relationship for meetings by the project, a fifth relationship for meetings by the task in the workflow, a sixth relationship for meetings by the technical field, and a seventh relationship for past meetings held prior to the current meeting. Additionally, a selection menu for classifying information may be displayed in the meeting history area 34, and the meeting room provision unit 112 may control the visualization of the relationship corresponding to any of the first to seventh relationships (e.g., project name) selected by the user through the selection menu (e.g., the fourth relationship, as shown in FIG. 10) in the meeting history area 34.

In one embodiment, when user input regarding a classification range and/or a classification period for the aforementioned relationships is received from the participant terminal 300, the meeting history object 24 may provide the aforementioned relationships by applying the classification range and/or the classification period corresponding to the user input.

For example, as a selection menu for the classification range through the online meeting room screen 30, a menu for selecting at least one category, such as a meeting host, a meeting participant, a department name, a project name, a specific workflow or a task in the workflow, and a technical field, is provided. Based on user input through the selection menu, the classification range applied to the search for past meetings associated with the current meeting may be limited. As an example, if a classification system for the department name is provided and selection input for one or more levels within the classification system is received, the relationship may be provided within the range of past meetings in which a user account belonging to the department name (e.g., product development team, product production team) corresponding to the selected level participated as meeting hosts or participants.

In another example, a selection menu for a time range of meeting duration 11 may be provided via the online meeting room screen 30 as a selection menu for the classification period, and based on user input via the selection menu, the time range may be limited to be applied to the search for past meetings associated with the current meeting. In one example, when an input for a predetermined date or a time range is received, the relationship may be provided within the range of past meetings having meeting duration 11 corresponding to the input (e.g., Jan. 1, 2023 to Dec. 31, 2023).

In one embodiment, the meeting history object 24 may provide the relationships by repeatedly applying the corresponding classification range and/or classification period whenever user input regarding the classification range and/or classification period for the relationships is received from the participant terminal 300. For example, as mentioned above, if the first classification range for the department name (e.g., product development team, product production team) is selected, the relationships of past meetings associated with the current meeting within the first classification range will be updated and provided. If the second classification range for the project (e.g., product development project: Prototype & Test) is additionally selected, the relationships of past meetings associated with the current meeting within both the first and second classification ranges will be cumulatively updated and provided.

In one embodiment, if at least one of the nodes visualizing the relationships is selected by the participant terminal 300, the meeting history object 24 may additionally visualize and provide a relationship different from the relationship of past meetings prior to the generation of the online meeting room 20, based on the classification information corresponding to the selected node. Here, a node is a point used to represent a hierarchical or sequential structure. For example, the node may be a point corresponding to each level or each meeting within the classification system, or may represent a hierarchical or sequential relationship between levels or could be a point (e.g., a connecting arrow) that corresponds to a connection between meetings (e.g., direct connection, indirect connection, derivative connection, etc.).

For example, as shown in FIG. 10, as a meeting history associated with a project, a list of meetings corresponding to each level within the classification system for project names may be displayed in the meeting history area 34. If user input requesting the history of other meetings linked to a specific level (e.g., market profile analysis and considerations) is received from the displayed levels, a new meeting history representing the relationships of the meetings associated with that level may be displayed in the meeting history area 34 by applying other classification information (e.g., past meetings conducted prior to the current meeting, meetings by task in the workflow, by department, etc.). The aforementioned other classification information may be selected by the user. As an example, as shown in FIG. 12, a history chart listing the connection relationships of the meetings corresponding to the selected level in chronological order according to meeting duration 11 may be displayed.

As mentioned above, through selecting a node within a single meeting history, other meeting histories associated with that node can be linked and provided. As a result, a user can easily check multiple meeting histories from various perspectives, thereby improving user convenience.

In one embodiment, when the basic information object 21 is updated based on the input from the participant terminal 300 regarding the meeting classification information 14 provided through the basic information area 31, the meeting history object 24 can update the relationships between the current meeting and past meetings based on the updated meeting classification information 14 and provide them in the meeting history area 34. In other words, as the meeting classification information 14 of the basic information object 21 is updated, the meeting history object 24 is also updated, and the meeting history provided in the meeting history area 34 may be updated as well.

In one embodiment, the meeting room provision unit 112 may provide some of the basic information object 21, the content object 22, the conversation thread object 23, and the meeting history object 24 during the provision of the online meeting room 20. For example, the online meeting room screen 30 may optionally include some of the basic information area 31, the content area 32, the conversation area 33, and the meeting history area 34 based on the user settings of the host terminal 200 or the participant terminal 300. Through these selected areas, some information of the online meeting room 20 may be displayed on the corresponding terminal.

In one embodiment, the meeting room provision unit 112, in response to a request from the host terminal 200 or the participant terminal 300 received during the provision process of the online meeting room 20, may add or associate some of the information from the components of a second online meeting room corresponding to a different meeting with some of the components of the first online meeting room corresponding to the current meeting.

In one embodiment, the meeting room provision unit 112, in response to a request received from the host terminal 200 or the participant terminal 300 during the provision process of the online meeting room 20, may add or associate some of the information from the components of a second online meeting room, corresponding to a different meeting, with some of the components of the first online meeting room, corresponding to the current meeting. For example, the meeting room provision unit 112, based on user input regarding the search results of the search unit 113 to be described later, may add a basic information object 21, a content object 22, or an access link thereto from the second online meeting room corresponding to the other meeting that was searched, to the conversation thread object 23 of the first online meeting room which is the current meeting. In this case, meeting participants may view the information of the other meeting through the access link shared in the chat room. As another example, the meeting room provision unit 112, upon request from the host terminal 200, may add or associate the content object 22 of the second online meeting room with the content object 22 of the first online meeting room. In this case, the meeting host may share videos from previous meetings with the participants through the video list of the meeting room. As another example, during the meeting creation process, the meeting room provision unit 112, upon request from the host terminal 200, may add the basic information object 21 of the second online meeting room to the basic information object 21 of the first online meeting room. In this case, the meeting host may share both the current meeting's information and the information of other meetings with the participants in the meeting room.

Meanwhile, the meeting room provision unit 112, during the process of controlling the meeting progress, may update the conversation thread object 23 to include the messages from the meeting participants received through the chat room provided in the conversation area 33. For example, the meeting room provision unit 112 may update the conversation thread object 23 so that the messages received from the host terminal 200 or the participant terminal 300 are processed sequentially.

In one embodiment, the meeting room provision unit 112 may manage each message to correspond to one of several message types. In one embodiment, the multiple message types may include at least one selected from a group consisting of question-based, answer-based, opinion-based, department-based, participant-based, and keyword-based. For example, the chat room implemented in the conversation area 33 provides a message input field for receiving messages and a selectable button for choosing the message type of each message. The meeting room provision unit 112 receives each message along with its message type and stores and manages each message in the conversation thread object 23, associating each message with its corresponding message type. As a result, in the conversation thread objects 23 of the multiple online meeting rooms 20 stored in the database 400, each message may be managed to correspond to one of the multiple message types.

In one embodiment, the meeting room provision unit 112 receives a question message from a first participant terminal 310 of one of the meeting participants, the questioner, and updates the conversation thread object 23 based on the received question message. In one embodiment, the question message may refer to a message with a message type corresponding to a question among the messages entered in the chat room. In another embodiment, the question message may refer to a message that is analyzed as a question through syntactic analysis (e.g., context understanding) or condition analysis (e.g., inclusion of question marks, etc.) of the message.

In one embodiment, the meeting room provision unit 112 may provide a question notification message regarding the addition of a question message to the host terminal 200 and/or the participant terminal 300. For example, when a question message is added to the chat room, the meeting room provision unit 112 may provide a question notification message informing the meeting host or the meeting participants that a question has been registered, based on user settings.

In one embodiment, the meeting room provision unit 112, when a responder is designated for the question message by the questioner, may provide a question notification message regarding the addition of the question message and the designation of the responder to only a second participant terminal 320 of the designated responder. For example, the chat room implemented in the conversation area 33 may provides a message input field along with a selectable button for choosing the user to receive the notification for the message, and the meeting room provision unit 112 may receive both the message and the user selection information to send the notification message only to the participant terminal 300 corresponding to the selected user.

In one embodiment, the meeting room provision unit 112 may receive the expected response information corresponding to the question message from the host terminal 200 or the participant terminal 300, and provide it to the first participant terminal 310 of the questioner. For example, each responder may convey to the questioner when they will provide an answer to each question through their response to the question notification message.

In one embodiment, the meeting room provision unit 112 may update the conversation thread object 130 based on the answer message received in response to the question message from the host terminal 200 or the participant terminal 300. Similarly, in one embodiment, the answer message may refer to a message with a message type corresponding to an answer among the messages entered in the chat room, or it may refer to a message that is registered as the answer to the corresponding question message.

In one embodiment, the meeting room provision unit 112 may provide an answer notification message regarding the addition of an answer message to the host terminal 200 and/or the participant terminal 300. In one embodiment, when a responder has been designated for the question message by the questioner, the meeting room provision unit 112 may provide the answer notification message regarding the addition of the answer message only to the first participant terminal 310 of the questioner.

As a result, since notifications are provided to meeting participants regarding the registration of questions or answers in the chat room, exchanges of opinions may occur more actively even during a non-real-time meeting. Additionally, because notifications regarding the registration of questions or answers in the chat room may be provided only to certain participants, the exchange of opinions may be carried out efficiently.

In one embodiment, when a responder for a question message is designated by the questioner, the conversation thread object 23 may grant access to the question message only to the designated responder. For example, each message included in the conversation thread object 23 may have its read permissions granted differently to each meeting participant, and the meeting room provision unit 112 can ensure that the read permissions for the question message and its corresponding answer message are granted only to the questioner and the designated responder.

In one embodiment, the question message may be updated in response to a modification request from the first participant terminal 310 of the questioner who wrote the question message, and the answer message may be updated in response to a modification request from the second participant terminal 320 of the responder who wrote the answer message. In other words, the question message and the answer message may each be modified by a user who generated the respective message. In one embodiment, when there is an update to a message, an identifiable indication of the text before and after the update and/or the update time may be provided along with the message.

In one embodiment, the meeting room provision unit 112, based on one of a set of pre-configured colors assigned to each question message, may control that the question message and the group of messages associated with the question message are displayed in the selected color in the chat room. For example, the conversation area 33 may provide a message input field, a selection button for choosing the message type, and a selectable button for choosing a color to be assigned to the question. The meeting room provision unit 112 may store the selected message type of the question in association with the specific chosen color, and when messages related to the question message (e.g., answer messages to the question) are received, these messages may also be stored in association with the same specific color. As a result, in the chat room, once the questioner selects the question type and writes the message, the question message is displayed in the specific chosen color, and any response messages from users answering that question will also be displayed in the same color.

In one embodiment, the meeting room provision unit 112 may control that when additional question messages are derived from a single question message, the additional question message and the group of messages related to it are displayed in a color similar to the color set for the original question message in the chat room. For example, if the messages related to the first question message are displayed in blue, the second question message derived during the discussion of the first question message, along with the related messages, may be displayed in a light blue color associated with the blue color family. Similarly, colors may be set and displayed based on the message author, or messages may be displayed in the same or similar color families based on factors such as the alphabet or consonants used in the message.

As mentioned above, by providing appropriate notifications or indicators regarding the registration or modification of messages for questions and answers exchanged non-real-time among meeting participants, non-real-time meetings may be conducted more effectively.

Meanwhile, when the end time of the meeting duration 11 of the online meeting room 20 approaches, the meeting room provision unit 112 may provide a message to the host terminal 200 or each participant terminal 300 inquiring about (i) the renewal of the meeting duration 11 or (ii) the generation of a new online meeting room connected to the online meeting room 20. For example, a meeting may have been conducted with specific participants during the meeting duration 11 on topic A, but for various reasons, a situation may arise where additional meetings on the same agenda (e.g., a second meeting on topic A) are necessary.

In one embodiment, when a renewal request for the meeting duration 11 is received from the host terminal 200 or each participant terminal 300, the meeting room provision unit 112 may update the meeting duration 11 of the online meeting room 20 to be extended in response to the renewal request. Alternatively, when a request to generate a new online meeting room connected to the online meeting room 20 is received from the host terminal 200 or each participant terminal 300, the meeting room provision unit 112 may generate a new online meeting room that at least shares video data, and include the connection relationship with the online meeting room 20 in the meeting classification information 14 of the new online meeting room. For example, when creating a second online meeting room connected to the first online meeting room, the basic information object 21 and the content object 22 of the first online meeting room are used to generate the basic information object 21 and the content object 22 of the second online meeting room, and the meeting classification information 14 of the basic information object 21 of the second online meeting room may include a direct connection relationship with the first online meeting room. Further, a new conversation thread object 23 for the second online meeting room may be generated, and based on the meeting classification information 14 of the basic information object 21 of the second online meeting room, a meeting history object 24 representing the relationship between the second online meeting room and other online meeting rooms may be generated.

In one embodiment, the meeting room provision unit 112 may receive a message and a restriction condition regarding access to the message from the first participant terminal 310 of a user who is one of the meeting participants. The meeting room provision unit 112 may provide the message and one or more messages generated in connection with the message to the participant terminals 300 of users who meet the restriction condition.

In one embodiment, the restriction condition may be a restriction condition for the user. For example, when a user inputs a message into a chat room, the user may set one or more other users among the participants who can view the message. In another embodiment, the restriction condition may be a restriction condition for a user grade. The user grade according to one embodiment may be set to include at least one selected from the group consisting of by job grade, by job position, by content security level, by department, by employment type, by workplace, and by affiliate, and may be set in various forms by various methods according to the policy of each organization. For example, when a user inputs a message into a chat room, the user may set one or more job grades that can view the message.

Accordingly, when discussing a specific topic during a meeting, a function may be provided that prevents certain participants from participating (e.g., viewing, listening) and allows only designated participants to participate. In short, a specific topic may be inappropriate for some participants depending on the content or job grade, and in such cases, smooth meeting progress can be achieved based on the above function.

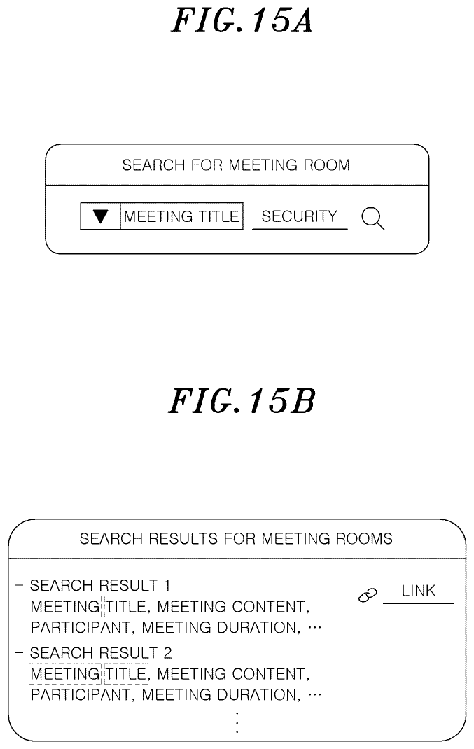

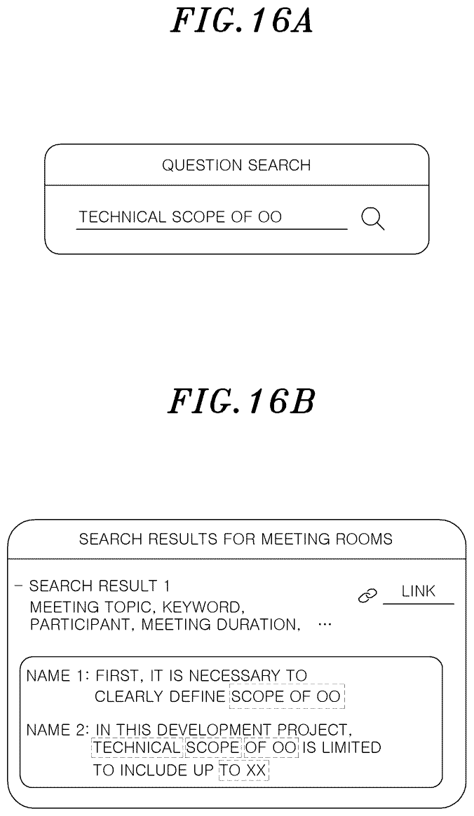

According to one embodiment of the present disclosure, the search unit 113 may be implemented to provide search results corresponding to user input for searching. Specifically, when user input for searching is received, the search unit 113 may provide search results for one or more online meeting rooms 20 corresponding to the user input from among the plurality of online meeting rooms 20 stored in the database 400, through the online meeting room screen 30. The online meeting room screen 30 according to one embodiment may further include a search area 35, where the above-mentioned search results may be displayed. The details of thereof will be described with reference to FIGS. 15A to 16.

FIGS. 15A and 15B are diagrams illustrating an example of the process in which meeting search results are displayed on the screen of the host terminal 200 and/or the participant terminal 300 according to one embodiment

Referring to FIG. 15A, the search unit 113 may receive user input for meeting room search. In one embodiment, a meeting room search menu with a search field for entering text is displayed in the search area 35, and the search unit 113 may receive user input entered through the search field from the terminal. For example, the text ‘security’ may be entered as a search condition.

In one embodiment, the search area 35 may display a meeting room search menu that includes one or more sets of search conditions, each set including an item selection button for selecting one of several candidate search items and a search field. Each candidate search item may correspond to an information element included in a meeting request, such as the meeting title, the meeting objective, the meeting content 12, the meeting duration 11, the meeting host, the meeting participants, or the meeting classification information 14. For example, an item corresponding to the meeting title may be selected, and the text ‘security’ corresponding to that item may be entered.

Referring to FIG. 15B, the search unit 113 may provide search results for one or more online meeting rooms 20 from the database 400 based on the similarity to the text corresponding to the user input and/or the frequency of occurrence of that text.

In one embodiment, the search unit 113 may provide search results including one or more online meeting rooms 20 among a plurality of online meeting rooms 20, where the similarity between the information included in each meeting request and the text in the user input exceeds a predetermined threshold. Here, similarity may include semantic similarity, which indicates the degree of similarity in meaning between corresponding words, phrases, or sentences, and syntactic similarity, which indicates the degree of similarity in the types or order of the morphemes that make up the text. In one embodiment, the similarity may be calculated using known algorithms such as morpheme analysis algorithms, text similarity calculation algorithms, or syntax analysis algorithms. For example, the search unit 113 may search for online meetings 20 from the database 400 where the text (e.g., “security”) exactly matches, or contains a similar text (e.g., “boyan”) with a syntactic similarity above a set threshold, or contains a similar text (e.g., “protection,” “encryption,” “security,” etc.) with a semantic similarity above a set threshold, which is included in at least one of the meeting title, the meeting objective, the meeting content 12, the meeting duration 11, the meeting host, the meeting participants, and the meeting classification information 14 of each meeting.

In one embodiment, the search unit 113 may provide search results including one or more online meeting rooms 20 among a plurality of online meeting rooms, based on the frequency of occurrence of the text in each conversation thread object, where the occurrence frequency of the text exceeds a preset threshold. In one embodiment, the occurrence frequency may be calculated based on at least one of the number of identical or similar texts (e.g., “security,” “protection,” “encryption,” “security,” etc.) contained in the total messages within the conversation thread object, the number of messages containing the identical or similar texts, and the ratio of those messages to the total messages. For example, the search unit 113 may search for online meeting rooms 20 from the database 400 where the identical text (e.g., “security”) or similar text (e.g., “protection,” “encryption,” “security,” etc.) appears more than a preset number of times in the messages of each chat room.

In one embodiment, the search results for the one or more online meeting rooms 20 may include information about each online meeting room 20 and/or access links to each online meeting room 20. In one embodiment, an identifiable indication may be provided for words, phrases, or sentences corresponding to the given text within the information of each online meeting room 20 included in the search results displayed in the search area 35. For example, a highlight may be displayed for the identical or similar text corresponding to the given text in the meeting information (e.g., meeting title, meeting content 12, etc.) of each online meeting room 20.

In one embodiment, the search results include search results for a plurality of online meeting rooms 20, and the order in which the information for each of the plurality of online meeting rooms 20 is displayed in the search results may be sorted based on the similarity and/or the frequency of occurrence. For example, the online meeting rooms 20 with a higher number of identical texts, greater similarity values for similar texts, or higher occurrence frequencies may be sorted to appear higher in the search results.

As mentioned above, search results related to similar meetings that may have taken place in the past based on the keywords provided by the user may be offered considering various aspects. Accordingly, the user may check similar meetings where the relevant keyword was actually discussed during the meeting process, thereby improving user satisfaction.

FIGS. 16A and 16B are diagrams illustrating an example of the process in which question-and-answer search results according to one embodiment are displayed on the screen of the host terminal 200 and/or the participant terminal 300.

Referring to FIG. 16A, the search unit 113 may receive user input for question search. In one embodiment, a question-and-answer search menu, including a search box for receiving text input, is displayed in the search area 35, and the search unit 113 may receive the user input entered in the search box from the corresponding terminal. For example, a text such as “technical scope of OO” may be entered as a search condition.

In one embodiment, the search area 35 may display a question-and-answer search menu that includes one or more sets of search conditions, which consist of a message type selection button for selecting one of a plurality of message types and a search box. For example, the message type corresponding to the question may be selected, and the text “technical scope of OO” may be entered corresponding to the selected message type.

In one embodiment, the search area 35 may display a question-and-answer search menu that includes one or more additional sets of search conditions, which consist of the aforementioned item selection buttons and search boxes. In such cases, during the subsequent search process, the search conditions for the respective items may be additionally applied.

Referring to FIG. 16B, the search unit 113 may provide search results for one or more online meeting rooms 20 from the database 400 based on whether the text corresponding to the user input in the chat room is included as a question or answer.

In one embodiment, the search unit 113 may provide search results for one or more online meeting rooms 20 from among the plurality of online meeting rooms 20, where the first text, which has a semantic similarity to the question corresponding to the user input, is included in each conversation thread object 23 and exceeds a set threshold. For example, the search unit 113 may provide search results for online meeting rooms 20 from the database 400, based on the message type (e.g., question) and text (e.g., the technical scope of OO) received through the question-answer search menu. Specifically, the search unit 113 may search for words, phrases, or sentences in the chat room's messages that have a semantic similarity exceeding a set threshold to the words, phrases, or sentences corresponding to the given text and match the specified message type.

In one embodiment, the search unit 113 may provide search results for one or more online meeting rooms 20, where the second text, which is analyzed as the response to the aforementioned question, is included in the respective conversation thread objects 23. For example, based on the message type (e.g., question) and text (e.g., the technical scope of OO) received through the question-answer search menu, the search unit 113 may search for online meeting rooms 20 from the database 400, where words, phrases, or sentences with a semantic similarity exceeding a set threshold to the corresponding text are included as response-type message categories in the chat room's messages.

In one embodiment, the search results for the one or more online meeting rooms 20 may include the first text and/or the second text extracted from the conversation thread object 23 of each online meeting room 20. In one embodiment, in the search area 35, an identifiable indication (e.g., highlighting) may be provided for the part of the message in the chat room of each online meeting room 20 that corresponds to the first text and/or the second text in the search results. The search results may also include an access link for each online meeting room 20, and in one embodiment, the access link may be a link that allows access to the location of the first text and/or the second text within the conversation thread object 23.

In one embodiment, when search conditions, including the aforementioned item selection button and search field, are received through the question-answer search menu, the search results may be obtained by additionally applying the search conditions for the corresponding items. For example, as shown in FIG. 15A, when a text (e.g., security) is entered along with the meeting title, a search may be conducted for meetings with that text as the meeting title, where questions or answers related to that text (e.g., the technical scope of OO) were discussed.

As mentioned earlier, search results may be provided regarding whether similar questions or answers related to the keywords provided by the user were discussed in past meetings. As a result, the user can review records of related questions or answers exchanged in previous meetings, even if the user did not directly ask the question in the current meeting, leading to increased user satisfaction. Additionally, unnecessary questions in actual meetings are reduced, which improves meeting efficiency.

In one embodiment, when a user input for sharing the above-mentioned search results is received, the search results may be added to the conversation thread object 23. For example, the search results, such as those shown in FIG. 15B or FIG. 16B, may be processed as a single message and shared in the chat room, and may be displayed in the conversation area 33.

Meanwhile, in the search process described in one embodiment, predefined metadata may be used. The information of the online meeting rooms 20 stored in the database 400 may be managed through multiple metadata, and may be utilized as index information for searching similar or corresponding information during the search process. For example, in the process of determining similarity or occurrence frequency, the search may be performed by comparing the text of a specific item corresponding to the search condition with the metadata text corresponding to the relevant item of each online meeting room 20, in order to determine whether they are similar beyond a set threshold.

In one embodiment, the metadata may include at least one of the information elements included in the online meeting room 20 described throughout the specification, and for example, may include the elements of the aforementioned meeting information 10. In one embodiment, the metadata may include text that is directly or indirectly processed from at least one of the aforementioned information elements, and for example, may include key keywords extracted from the corresponding basic information object 21, frequently occurring keywords or meeting conclusions derived from the analysis of the messages in the corresponding conversation thread object 23.

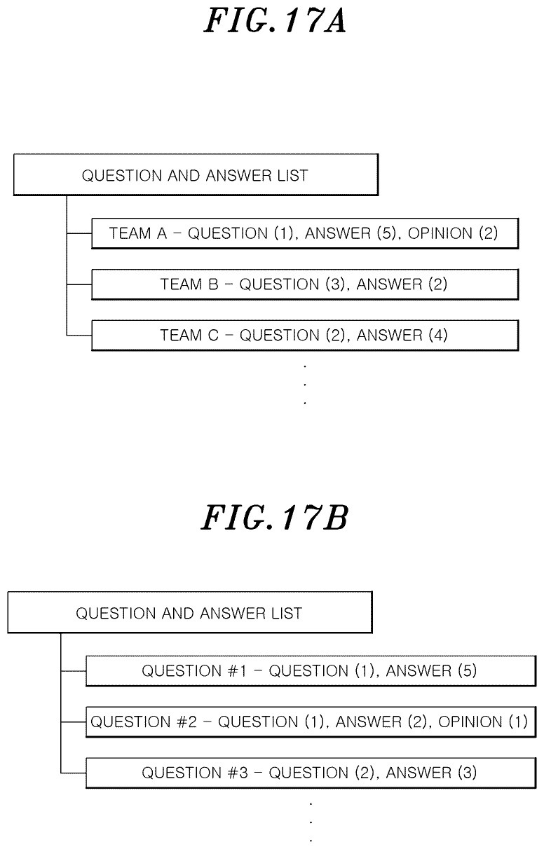

According to one embodiment of the present disclosure, the organizing unit 114 may provide a summary result for the information of the online meeting room 20 obtained during the meeting duration 11. In one embodiment, the summary result may include the summary of the information of the online meeting room 20 obtained from the start time to the current time within the meeting duration 11 and/or the summary of the information of the online meeting room 20 obtained after the end of the meeting duration 11. The online meeting room screen 30 according to one embodiment further includes an organizing area 36, where the aforementioned summary result may be displayed. This will be explained with reference to FIGS. 17A and 17B.

FIGS. 17A and 17B are diagrams illustrating an exemplary process of displaying the summary result on the screen of the host terminal 200 and/or the participant terminal 300 according to one embodiment.

Referring to FIGS. 17A and 17B, the organizing unit 114 may provide a result of sorting the messages included in the conversation thread object 23 based on their corresponding message types as the summary result. As mentioned above, the message type may include at least one selected from a group including question-based, answer-based, opinion-based, department-based, participant-based, and keyword-based types. Each message in the conversation thread object 23 is stored in correspondence with one of the message types selected by the user during the process of being added to the chat room, and each message may be stored as a message (e.g., an answer message) associated with another message (e.g., a question message) selected by the user. The organizing unit 114 may provide a message-type-specific list by sorting the messages in the conversation thread object 23 according to their respective message types

For example, as shown in FIG. 17A, the organizing unit 114 may provide a question-answer list that organizes messages according to each message type in a hierarchical structure. The question-answer list may have a hierarchical structure in which the upper level corresponds to message types such as by department, participant, or keyword, and the lower level corresponds to message types such as question, answer, and/or opinion. As an example, messages presented respectively by Team A, Team B, and Team C, which are the departments to which the meeting participants belong, may be sorted by question, answer, and opinion.

Another example, as shown in FIG. 17B, is that the organizing unit 114 may provide a question-answer list where messages are sorted in a chronological structure according to each message type. The question-answer list may have a chronological structure in which a plurality of message groups, each containing a question message and its associated messages (e.g., answer, opinion, question), are sorted according to the creation time of the representative message (e.g., question message, initial message). For example, the group of each question message and its corresponding answer messages may be sorted in order of the creation time of the question messages, from earliest to latest.

In one embodiment, the list by message type may include the number of messages for each message type and/or access links to the messages corresponding to each message type. For example, in the organizing area 36, the list by message type may visualize the number of questions or answers registered for each department. Further, when an access link for messages corresponding to each message type is selected through the list by message type, the screen in the conversation area 33 may be updated to visualize the messages located at the corresponding position of the access link.

In one embodiment, the list by message type may be sorted based on the message creation time and/or the question topic corresponding to the message. For example, the messages may be sorted in ascending order (from earliest to latest) or descending order (from latest to earliest) based on the message creation time. Alternatively, groups of messages related to each question message may be sorted and provided, where one or more key keywords corresponding to the question topic are extracted through text analysis of each question message, and the groups are sorted and presented based on the similarity of each key keyword.

As mentioned above, during the meeting, the messages exchanged in the chat room so far may be sorted according to message types such as questions or answers. As a result, meeting participants may more intuitively understand the flow of the conversation that has taken place so far and participate in the meeting, regardless of when they join the meeting room.

In one embodiment, the organizing unit 114 may provide meeting results obtained from the messages included in the conversation thread object 23 based on a pre-stored artificial intelligence model as the organizing results. An example of an artificial intelligence model that may be used is a generative artificial intelligence (AI) model, which utilizes a deep learning model trained on a large-scale dataset. For example, the organizing unit 114 may provide the messages included in the conversation thread object 23 to a pre-trained generative AI model, and from the generative AI model, obtain meeting results that include a summary of the key points of the conversations, conclusions derived from the main content, and any necessary tasks. Such meeting results may be obtained as a summary result for a completed meeting when the meeting duration 11 has passed, or as a summary result for an ongoing meeting in response to a user request during the meeting duration 11.

In one embodiment, when the meeting results are obtained, the organizing unit 114 may provide the meeting results in the organizing area 36 and deliver a notification message about the meeting results to each participant terminal 300. In one embodiment, when a user account designated as the meeting reference by the meeting host exists for the meeting, the terminal of that user account is granted access rights only to view the meeting results, and a notification message about the meeting results may be provided.

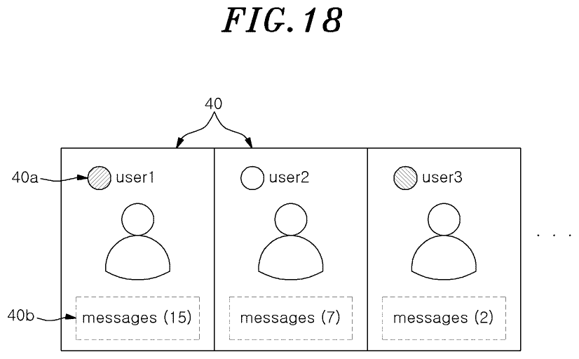

According to one embodiment of the present disclosure, the participant information provision unit 115 may be implemented to provide non-real-time participation information about the online meeting room 20 for the meeting host and participants. In one embodiment, the non-real-time participation information may include information about the meeting host and participants in the meeting, and/or information about whether each participant is involved in the relevant meeting and/or the status of their participation. The online meeting room screen 30 according to one embodiment may further include a participation information area 37, and the aforementioned non-real-time participation information may be displayed in the participation information area 37. This will be described with reference to FIG. 18.

FIG. 18 is an exemplary diagram illustrating a process in which non-real-time participation information is displayed on the screen of the host terminal 200 and/or the participant terminal 300 according to one embodiment.

Referring to FIG. 18, the participant information provision unit 115 may obtain non-real-time participation information for each of the meeting host and participants in the online meeting room 20. In one embodiment, the non-real-time participation information may include at least one of (i) initial connection time, most recent connection time, time of participation response confirmation, connection frequency, current connection status for the online meeting room 20, and (ii) a conversation participation rate for the conversation thread object 23. The connection frequency, for example, may be determined based on the number of times the online meeting room 20 is accessed during meeting duration 11. Further, the conversation participation rate may be determined, for example, based on the number or percentage of messages added by the user among the messages included in the conversation thread object 23.

The participant information provision unit 115 may provide a participant list, including acquired user information and/or non-real-time participation information, for each meeting host and participant to the participation information area 37. In one embodiment, the participant list includes participant areas 40 corresponding to meeting participants, and each participant area 40 may provide user information (e.g., name, department, profile, image, etc.) and non-real-time participation information corresponding to each meeting participant. In one embodiment, each participant area 40 may include a connection icon 40a as an identifiable indicator to show whether the user is currently connected to the online meeting room 20. In addition, each participant area 40 may include a display section 40b to show the user's non-real-time participation information, such as the number of messages left in the chat room and the most recent connection time.

In an embodiment, the participant information provision unit 115 may provide a participant list that includes the results of sorting participant information corresponding to meeting participants based on non-real-time participation information for each of the meeting host and participants' online meeting rooms 20. For example, the participant list may be provided with the user information of the meeting participants sorted in a vertical or horizontal manner, and the user information of the meeting participant is prioritized to be exposed at the top or left side of the participant list based on factors such as the faster order of initial connection to the online meeting room 20, the faster order of most recent connection, the faster order of acceptance response to the invitation message, the higher connection frequency, the case of being currently connected, and/or the higher participation rate in the chat room.

For example, in the case of FIG. 18, a connection icon 40a indicating the current connection status of each meeting participant in the participant list is displayed in the participant area 40, where the connection status is represented by colors (e.g., green, gray), and a display area 40b showing non-real-time participation information (e.g., the number of messages left in the chat room) is provided. The user information is sorted and displayed in the participant areas 40 in descending order, from the highest to the lowest message count.

In one embodiment, the participant information provision unit 115 may provide a participation score for each meeting participant based on their non-real-time participation information. For example, the participant information provision unit 115 may calculate numerical values for each meeting participant's initial connection time, most recent connection time, participation response confirmation time, connection frequency, current connection status, and conversation participation rate by applying pre-stored mathematical formulas, and may apply the same or different weights set for each factor to the calculated numerical values and compute a weighted average, thereby obtaining the participation score. These numerical values and/or participation scores may be provided in the display area 40b or may be used to sort the above-mentioned participant information. As one example, if the participation score is equal to or greater than a predetermined threshold value, an image indicating active participation may be provided. As another example, as the participation score increases, the participant's information may be preferentially displayed at the top or left side of the participation information area 37.

As mentioned above, the current status of the meeting participants, such as current connection status, participation level, or the like, may be provided. Accordingly, even during a non-real-time meeting, users can engage in real-time discussions with participants who are currently connected, and as the participation status of the meeting participants is shared, the meeting may become more active.”

In one embodiment, the participant information provision unit 115 may obtain the viewing information of each meeting participant's video data based on the connection information for the content object 22 of each participant terminal 300. The participant information provision unit 115 may record whether each meeting participant has watched the video data of the content object 22. For example, if the ratio of the viewing time by the participant to the total playback time of the video data exceeds a preset ratio (e.g., 50%), it may be recorded as having been watched.”

In one embodiment, the participant information provision unit 115 may provide the aforementioned viewing information and/or non-real-time participation information of each meeting participant to the host terminal 200. For example, in the participation information area 37 of the host terminal 200, the video viewing status, the participation response confirmation time, and the most recent connection time of each meeting participant may be provided.

In one embodiment, the participant information provision unit 115 may grant write permissions for the conversation thread object 23 to the participant terminal 300 whose viewing of the video data is confirmed, based on the aforementioned viewing information of each meeting participant. For example, when the start time of the meeting duration 11 arrives and the meeting begins, access to the online meeting room 20 is granted to each meeting participant whose participation response has been confirmed by the meeting room provision unit 112. However, for participants whose video viewing has not been confirmed, only read permissions for the conversation thread object 23 are granted, while participants whose video viewing has been confirmed may be additionally granted write permissions by the participant information provision unit 115. In this case, each meeting participant must watch the video registered by the meeting host in order to participate in the conversation in the chat room, so the meeting participants may be guided to fully understand the video content before joining the meeting.

Meanwhile, the configuration of the online meeting room screen 30 and the layout of each area within the screen shown above are merely examples and may be modified and implemented in various forms.

According to one embodiment, above features of the computer device 100 for providing the online meeting room 20 may be performed by at least partially using a generative AI.

In one embodiment, the meeting room provision unit 112 may the meeting history object 24 by using the generative AI. When the online meeting room 20 is generated, the meeting room provision unit 112 may generate the meeting history object 24 by using the generative AI, and provide the meeting history object 24 to each participant terminal 300 in response to a request from each participant terminal 300 during the meeting process through the online meeting room 20.

In one embodiment, the generative AI may be trained to generate the meeting history object 24 that visualizes a historical relationship of meetings by using a plurality of training datasets based on information about the online meeting room 20 including the meeting classification information 14. For example, the generative AI may be trained that, when a meeting identifier or the meeting classification information 14 of the corresponding meeting is given as input, it searches for meetings having the meeting classification information 14 related to the corresponding meeting from the database 400 and outputs the meeting history object 24 including the historical relationship between the meeting and the searched meetings in a sequential and/or hierarchical manner. In one embodiment, the generative AI may include a generative AI model that is pre-trained using large datasets based on a Transformer model, and may be implemented based on, for example, a GPT (Generative Pre-trained Transformer), BERT (Bidirectional Encoder Representations from Transformer), a model derived from this, or etc. For example, the generative AI may be obtained by applying fine-tuning using the plurality of training datasets to the pre-trained generative AI model described above.

In another embodiment, at least some of the operations of the search unit 113, the organizing unit 114, and the participant information provision unit 115 may be performed by using the generative AI. For example, in a similar manner to the above, a generative AI trained to perform the search function for other conference rooms or similar questions and answers related to a question message and/or the message organizing function according to the message type in a chat room may be used, but is not limited thereto.

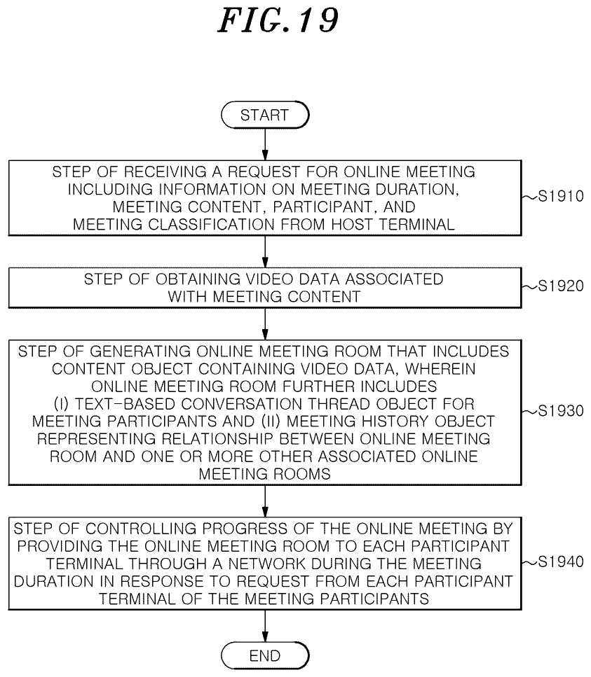

FIG. 19 illustrates an exemplary flowchart of a computer-implemented method for implementing an online meeting in a non-real-time manner by the meeting service device 100 according to one embodiment. FIG. 19 may be understood with reference to all the embodiments described above

With reference to FIG. 19, in step S1910, the meeting service device 100 may receive a request for the online meeting from the host terminal 200, which includes meeting duration 11, meeting contents 12, participant information 13, and meeting classification information 14. In one embodiment, the meeting classification information 14 may include at least one classification information selected from the group consisting of a meeting host, meeting participants, a department name, a project name, a specific work or task in the workflow, a technical field, and past meetings conducted prior to the current meeting.

In one embodiment, the meeting service device 100 may send an invitation message including the meeting duration 11 and the meeting contents 12 to the participant terminals 300 of at least three meeting participants, and if participation responses for the invitation message are received from at least two meeting participants' participant terminals 300 within a predetermined period, the received request for the online meeting may be approved. In one embodiment, the meeting service device 100 may send an approval message for the approval to the host terminal 200.

In step S1920, the meeting service device 100 may obtain video data related to the meeting content 12. In one embodiment, when the meeting content 12 included in the request for the online meeting contains video data, the meeting service device 100 may obtain the video data from the meeting content 12.

In the first embodiment, the step of obtaining the video data may be performed in response to the approval of the request for the online meeting.

In the second embodiment, the step of obtaining the video data may be performed before the step of receiving the request for the online meeting in response to a request from the host terminal 200.

In the third embodiment, after receiving the request for the online meeting, the meeting service device 100 may obtain additional video data from the host terminal 200, the participant terminal 300, or a terminal of another user designated by the host terminal 200, and the content object 22 may further include the additional video data.

In step S1930, the meeting service device 100 may generate an online meeting room 20 that includes the content object 22 containing video data. The online meeting room 20 may further include (i) the text-based conversation thread object 23 for the meeting participants and (ii) the meeting history object 24 representing the relationship between the online meeting room 20 and one or more other online meeting rooms 20 associated with the online meeting room 20. In one embodiment, the online meeting room 20 may further include (iii) a basic information object 21 containing the request for the online meeting.

In step S1940, the meeting service device 100 may control the progress of the online meeting by providing the online meeting room 20 to each participant terminal 300 through the network during the meeting duration 11 in response to a request from each participant terminal 300 of the meeting participants, so that the online meeting proceeds with non-real-time participation by the meeting participants. In one embodiment, the meeting service device 100 may provide the online meeting room 20 to each participant terminal 300 of the meeting participants whose participation responses to the request for the online meeting have been confirmed.

In one embodiment, the meeting history object 24 may visualize to provide the historical relationship between the online meeting in the online meeting room 20 and meetings prior to the generation of the online meeting room 20, in a sequential and/or hierarchical manner, based on the meeting classification information 14. In one embodiment, the meeting service device 100 may apply the received classification range and/or classification period to the meeting history object 24 to provide the historical relationship, when the user input regarding the classification range and/or classification period for the historical relationship is received from the participant terminal 300. In one embodiment, the meeting history object 24 may include (i) a history chart visualizing the relationship, (ii) a meeting summary summarizing the meeting results of each of the one or more other online meeting rooms 20, and (iii) at least one access link to each of the one or more other online meeting rooms 20. In one embodiment, when at least one among a plurality of nodes visualizing the historical relationship is selected by the participant terminal 300, the meeting history object 24 may additionally visualize to provide a historical relationship different from the above historical relationship of the meetings based on the classification information corresponding to the selected node.

In one embodiment, the meeting service device 100 may update the conversation thread object 23 based on a question message received from the first participant terminal 310 of one of the participants who is the questioner, provide a question notification message regarding the addition of the question message to the host terminal 200 and/or participant terminal 300, and update the conversation thread object 23 based on an answer message received from the host terminal 200 and/or the participant terminal 300 in response to the question message.

In one embodiment, the meeting service device 100 may receive a user input for searching meeting rooms, and from among a plurality of online meeting rooms 20, provide search results including one or more online meeting rooms 20. The one or more online meeting rooms 20 here have (i) the similarity between information in each request for an online meeting and the text in the user input, and/or (ii) the frequency of occurrence of the corresponding text in each conversation thread object 23 being equal to or greater than a predetermined level.

In one embodiment, the meeting service device 100 may receive a user input for question search and provide search results including one or more online meeting rooms 20 among a plurality of online meeting rooms. Each of the one or more online meeting rooms 20 here includes the conversation thread object 23 that has the following: (i) the first text with a semantic similarity to the question in the user input that is equal to or greater than a predetermined level, and/or (ii) the second text identified as an answer to the question.

According to one embodiment of the present disclosure, users are able to participate in online meetings non-real-time, without being constrained by time or location, allowing the meeting to proceed more effectively. Additionally, as the non-real-time meeting is conducted based on video data, the goals of the meeting may be achieved more effectively. Furthermore, since the users may check the history of past meetings related to the current meeting, the reduction of redundant or unnecessary arguments helps the meeting proceed more effectively.

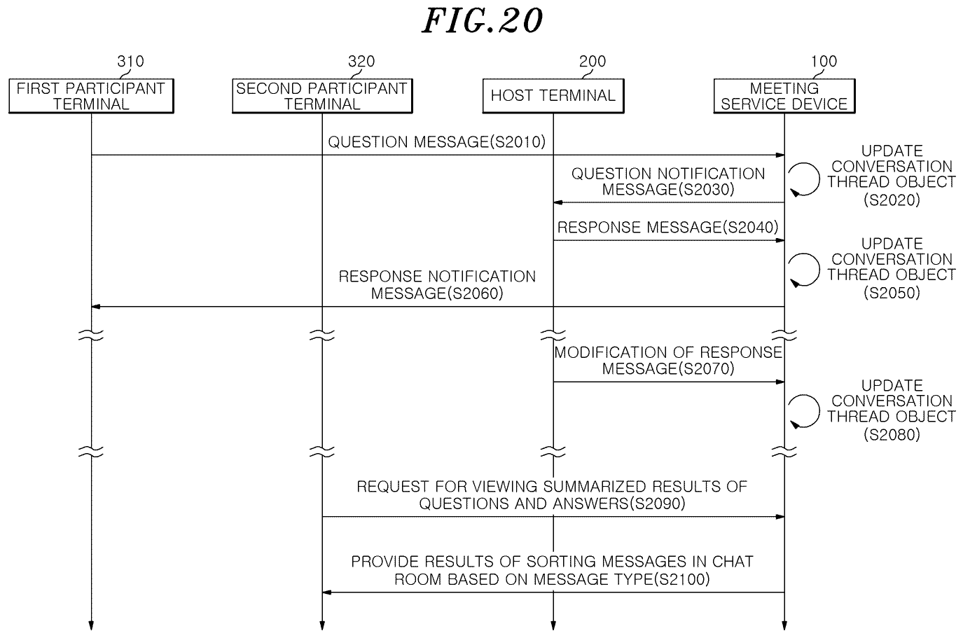

FIG. 20 illustrates an exemplary flowchart of a computer-implemented method for implementing an online meeting in a non-real-time manner by of the meeting service device 100 according to another embodiment.

Referring to FIG. 20, in step S2010, the meeting service device 100 may receive a question message from the first participant terminal 310 of a questioner among the meeting participants, and in step S2020, the conversation thread object 23 is updated to include the received question message.

In step S2030, the meeting service device 100 may provide a question notification message regarding the addition of the question message to the host terminal 200. In one embodiment, if the meeting service device 100 designates a second meeting participant as the responder to the question message by the first participant terminal 310, it may provide a notification message regarding the addition of the question message and the designation of the responder to the second participant's second participant terminal 320.

In step S2040, the meeting service device 100 may receive a response message corresponding to the question message from the host terminal 200, and in step S2050, it may update the conversation thread object 130 to include the received response message. Additionally, in step S2060, the meeting service device 100 may provide a response notification message regarding the addition of the response message to the host terminal 200 and/or the participant terminal 300.

In step S2070, the meeting service device 100 may receive a modification request for a response message written by the meeting host from the host terminal 200, and in step S2080, it may update the conversation thread object 130 to include the modified response message corresponding to the modification request. In one embodiment, the modified response message may be provided together with a modified text and a modification time in the chat room.

As the steps similar to steps S2010 through S2060 are repeated, questions and answers by a plurality of meeting participants may be exchanged non-real-time in the chat room. Further, as the steps similar to steps S2070 through S2080 are repeated, messages in the chat room may be modified non-real-time based on the request of the author.

In step S2090, the meeting service device 100 may receive a request for viewing the summary of the question and answer results from the second participant terminal 320. Alternatively, it may be considered that the above-mentioned view request has been received when the second participant terminal 320 connects to the online meeting room 20.

In step S2100, the meeting service device 100 may provide the result of sorting the messages according to the message type of messages included in the conversation thread object 23 to the second participant terminal 320. For example, a list of sorted messages by message type, such as by question, answer, opinion, department, participant, and keyword, may be displayed on the second participant terminal 320.

According to one embodiment of the present disclosure, since users can better understand the status of questions and answers being exchanged while viewing notifications or the results of organized questions and answers during the non-real-time meeting, the meeting can proceed more effectively.

Meanwhile, the steps illustrated above are merely examples, and within the scope that does not deviate from the essential characteristics of each technical feature described throughout the specification, the order, combination, branching, functions, and the entities performing the tasks can be variously implemented in the form of additions, omissions, or modifications.

Meanwhile, a person having ordinary skill in the art of the present disclosure will understand that the various exemplary logic blocks, modules, processors, means, circuits, and algorithm steps described in relation to the embodiments disclosed here can be implemented by electronic hardware, programs of various forms (referred to as software here for convenience), or a combination of both design codes or all of these.

To clearly explain the interoperability of hardware and software, various exemplary components, blocks, modules, circuits, and steps have been generally described above in relation to their functions. Whether these functions are implemented as hardware or software depends on the design constraints imposed on a specific application and the overall system. A person having ordinary skill in the technical field of the present disclosure can implement the functions described in various ways for each specific application; however, such implementation decisions should not be interpreted as falling outside the scope of the present disclosure.

The various embodiments presented here can be implemented as methods, devices, or articles of manufacture using standard programming and/or engineering techniques. The term “article of manufacture” includes any computer-readable storage device, carrier, or medium that is accessible from a computer-readable storage device. For example, a computer-readable storage medium includes magnetic storage devices (e.g., hard disks, floppy disks, magnetic strips, etc.), optical disks (e.g., CDs, DVDs, etc.), smart cards, and flash memory devices (e.g., EEPROM, cards, sticks, key drives, etc.), but is not limited to these. Additionally, the various storage media presented here include one or more devices and/or other machine-readable media for storing information.

It should be understood that the specific order or hierarchy of the steps in the presented processes is an example of an approach. Based on design priorities, the specific order or hierarchy of the steps in the processes may be rearranged within the scope of the present disclosure. The attached method claims provide elements of various steps in a sample order, but this does not mean they are limited to the presented specific order or hierarchy.

What is claimed is:

1. A computer-implemented method for implementing an online meeting in a non-real-time manner by a plurality of users using a meeting service device, wherein the meeting service device includes a memory, a processor, and one or more programs stored in the memory and configured to be executed by the processor, the method comprising:
receiving a request for the online meeting including meeting duration, meeting content, information about meeting participants, and meeting classification information from a host terminal;
obtaining video data related to the meeting content;
generating an online meeting room that includes a content object containing the video data, wherein the online meeting room further includes (i) a conversation thread object based on text input from the meeting participants, and (ii) a meeting history object representing a historical relationship between the online meeting room and one or more other online meeting rooms associated with the online meeting room; and
controlling a progress of the online meeting by providing the online meeting room to each participant terminal through a network during the meeting duration in response to a request from each participant terminal of the meeting participants, so that the online meeting proceeds with non-real-time participation by the meeting participants.

2. The method of claim 1, wherein the meeting classification information includes at least one classification information selected from the group consisting of a meeting host, a meeting participant, a department name, a project name, a specific work or task in a workflow, a technical field, and a past meeting held prior to a current meeting.

3. The method of claim 1, wherein the online meeting room further includes:
a base information object containing the received request for the online meeting, and
wherein the controlling the progress of the online meeting with the non-real-time participation further includes:
receiving user input regarding the meeting classification information from a participant terminal; and
updating the base information object and/or the meeting history object based on the received user input.

4. The method of claim 1, wherein the meeting history object visualizes to provide the historical relationship between the online meeting in the online meeting room and meetings prior to the generation of the online meeting room, in a sequential and/or hierarchical manner, based on the meeting classification information.

5. The method of claim 4, wherein the meeting service device, upon receiving the user input from the participant terminal regarding a classification range and/or a classification period for the historical relationship, applies the received classification range and/or the classification period to the meeting history object to provide the historical relationship.

6. The method of claim 4, when at least one of the nodes among a plurality of nodes visualizing the historical relationship is selected by the participant terminal, the meeting history object further visualizes to provide an additional historical relationship, different from the historical relationship of the meetings, based on the classification information corresponding to the selected node.

7. The method of claim 1, wherein the meeting history object includes at least one selected from the group consisting of a history chart visualizing the historical relationship, a meeting summary for each of the one or more other online meeting rooms, and at least one access link to each of the one or more other online meeting rooms.

8. The method of claim 1, further comprising:
receiving user input for searching a meeting room; and
providing search results including one or more online meeting rooms among a plurality of online meeting rooms stored in a database of the meeting service device;
wherein the one or more online meeting rooms have (i) a similarity between information in each request for an online meeting and a text in the user input and/or (ii) a frequency of occurrence of the text in each conversation thread object being equal to or greater than a predetermined level.

9. The method of claim 1, further comprising:
receiving user input for searching a question; and
providing search results including one or more online meeting rooms, among a plurality of online meeting rooms stored in a database of the meeting service device; each of the one or more online meeting rooms includes the conversation thread object that has (i) a first text with a semantic similarity to the question in the user input that is equal to or greater than a predetermined level, and/or (ii) a second text identified as an answer to the question.

10. The method of claim 1, wherein the controlling the progress of the online meeting with the non-real-time participation includes:
providing the online meeting room to each participant terminal whose participation response to the request for the online meeting has been confirmed, and
wherein the method further comprises:
sending an invitation message including the meeting duration and the meeting content to each of the participant terminals of the meeting participants; a count of the meeting participants is not less than 3;
approving the request for the online meeting when the participation response for the invitation message are received from at least two meeting participants' terminals within a predetermined period; and
sending an approval message for the approval of the request for the online meeting to the host terminal.

11. The method of claim 10, wherein the obtaining the video data is performed in response to the approval of the request for the online meeting.

12. The method of claim 1, wherein the obtaining the video data is performed before receiving the request for the online meeting in response to a request from the host terminal.

13. The method of claim 1, wherein the obtaining the video data includes obtaining the video data from the meeting content when the meeting content includes the video data.

14. The method of claim 1, wherein the controlling the progress of the online meeting with the non-real-time participation further includes:
updating the conversation thread object based on a question message received from a first participant terminal of a questioner among the meeting participants;
providing a question notification message regarding an addition of the question message to the host terminal and/or the participant terminal; and
updating the conversation thread object based on an answer message received in response to the question message from the host terminal or the participant terminal,
wherein the providing the question notification message includes:
when a responder is designated by the questioner for the question message, providing the question notification message regarding the addition of the question message and the designation of the responder only to a second participant terminal of the designated responder.

15. The method of claim 1, further comprising:
providing a result of sorting messages according to a message type of messages included in the conversation thread object,
wherein the message type includes at least one selected from the group consisting of a question-based type, an answer-based type, an opinion-based type, a department-based type, a participant-based type, and a keyword-based type,
wherein the conversation thread object includes a thread of conversation units based on at least one input selected from the group consisting of a text, an image, a video, and an audio of the meeting participants.

16. The method of claim 1, wherein the receiving the request for the online meeting further includes:
recommending candidate meeting participants to the host terminal based on the meeting content and/or the meeting classification information;
receiving, from the host terminal, user input for a plurality of meeting participants including the recommended candidate meeting participants; and
determining the meeting participants of the online meeting based on the user input.

17. The method of claim 1, wherein the providing the online meeting room further includes:
providing a participant list including a result of sorting user information of the meeting participants based on non-real-time participation information of each of the meeting participants for the online meeting rooms,
wherein the non-real-time participation information includes at least one selected from the group consisting of initial access time, most recent access time, confirmation time of participation response, access frequency, current access status for the online meeting room, and conversation participation rate for the conversation thread object.

18. The method of claim 1, further comprising:
obtaining viewing information of the video data for each of the meeting participants based on access information to the content object of the participant terminal of each meeting participant; and
providing the viewing information of each meeting participant to the host terminal,
wherein the controlling the progress of the online meeting with the non-real-time participation further includes:
granting write permission to the conversation thread object based on the viewing information to the participant terminal where whose viewing of the video data is confirmed.

19. A non-transitory computer-readable recording medium storing a computer program programmed to perform each step included in a method for implementing an online meeting in a non-real-time manner by a plurality of users using a meeting service device, the method comprising:
receiving a request for the online meeting including meeting duration, meeting content, information about meeting participants, and meeting classification information from a host terminal;
obtaining video data related to the meeting content;
generating an online meeting room that includes a content object containing the video data, wherein the online meeting room further includes (i) a conversation thread object based on text input from the meeting participants, and (ii) a meeting history object representing a historical relationship between the online meeting room and one or more other online meeting rooms associated with the online meeting room; and
controlling a progress of the online meeting by providing the online meeting room to each participant terminal through a network during the meeting duration in response to requests from the meeting participants, so that the online meeting proceeds with non-real-time participation by the meeting participants.

20. A meeting service device for implementing an online meeting in a non-real-time manner by a plurality of users, comprising:
a memory configured to store at least one instruction; and
a processor configured to execute the one or more instructions stored in the memory, wherein the instructions, when executed by the processor, cause the processor to:
receiving a request for the online meeting including meeting duration, meeting content, information on meeting participants, and meeting classification information from a host terminal;
obtaining video data related to the meeting content;
generating an online meeting room that includes a content object containing the video data, wherein the online meeting room further includes (i) a conversation thread object based on text input from the meeting participants, and (ii) a meeting history object representing a historical relationship between the online meeting room and one or more other online meeting rooms associated with the online meeting room; and
controlling a progress of the online meeting by providing the online meeting room to each participant terminal through a network during the meeting duration in response to requests from the meeting participants, so that the online meeting proceeds with non-real-time participation by the meeting participants.
